(19) United States
(12) Patent Application Publication
(10) Pub. No.: US 2025/0094478 A1
(43) Pub. Date: Mar. 20, 2025

(54) SYSTEMS AND METHODS FOR AUTOMATING THE CONSTRUCTION AND ORGANIZATION OF A TAXONOMY

(71) Applicant: University of Florida Research Foundation, Inc., Gainesville, FL (US)

(72) Inventor: Aaron Costin, Gainesville, FL (US)

(21) Appl. No.: 18/293,521

(22) PCT Filed: Jul. 29, 2022
(86) PCT No.: PCT/US2022/074328

§ 371 Date: Jan. 30, 2024

Related U.S. Application Data
(60) Provisional application No. 63/227,517, filed on Jul. 30, 2021.

(51) Int. Cl. G06F 16/36; G06F 16/11; G06F 16/31

(52) U.S. Cl. CPC G06F 16/36; G06F 16/116; G06F 16/322

(57) ABSTRACT

Various examples are provided related to taxonomy construction and organization. In one example, a system includes a computing device and machine readable instructions that, when executed, cause the computing device to at least: receive an input that identifies a term and a definition of the term; generate a globally unique identifier (GUID) that uniquely identifies the input; store the input and the GUID in a data store; and assign the input and the GUID to a taxonomy tree, wherein the input and the GUID are assigned to a node within a hierarchy of the taxonomy tree. In another example, a method includes receiving, by a computing device, an input identifying a term and a definition of the term; generating a GUID that uniquely identifies the input; and assigning the input and the GUID to a node within a hierarchy of a taxonomy tree.

### CROSS REFERENCE TO RELATED APPLICATIONS

This application claims priority to, and the benefit of, co-pending U.S. provisional application entitled “Systems and Methods for Automating the Construction and Organization of a Taxonomy” having Ser. No. 63/227,517, filed Jul. 30, 2021, which is hereby incorporated by reference in its entirety.

### BACKGROUND

Currently, extensive time may be spent on tasks associated with creating, modifying, and exporting a taxonomy. For example, the process of capturing and putting domain knowledge into usable forms require manual tasks, which result in a loss of time and resources.

### SUMMARY

Aspects of the present disclosure are related to taxonomy construction and organization. A taxonomy is a hierarchical framework, schema, or structure for the organization of objects (e.g., data, classes, elements, etc.) to be used in the application of logic and function of computer systems. There is no one way to define a taxonomy and multiple taxonomies can be applied on the same objects depending on the reference view, user, or domain. There are also many formats and schemas that the taxonomy can be defined in. The organization of taxonomies can be endless since there are many users of the objects, thus the creation and management of taxonomies can be cumbersome and time consuming.

In one aspect, among others, a system comprises a computing device comprising a processor and a memory; and machine readable instructions stored in the memory that, when executed by the processor, cause the computing device to at least: receive an input that identifies a term and a definition of the term; generate a globally unique identifier (GUID) that uniquely identifies the input; store the input and the GUID in a data store; and assign the input and the GUID to a taxonomy tree, wherein the input and the GUID are assigned to a node within a hierarchy of the taxonomy tree. In one or more aspects, the machine readable instructions, when executed by the processor, can cause the computing device to export the taxonomy tree as an Excel or XML file. The machine readable instructions can cause the computing device to store the taxonomy tree as an Excel or XML file and can further cause the computing device to bi-directionally convert the taxonomy tree from the Excel to the XML file.

In various aspects, the hierarchy can comprise one or more sub-nodes, the one or more sub-nodes sharing one or more attributes with the node. The taxonomy tree can be configured to be automatically mapped to an ontology. The ontology can comprise a World Wide Web Consortium (W3C) format, a JSON format or an Industry Foundation Classes format. The ontology can comprise a Web Ontology Language (OWL), a Resource Description Framework, NTriples format, JSON-LD format, NQuads format, Turtle format, or TriG format. The input can further identify at least one of a source of the term, a date of when the definition was created, an abbreviation of the term, one or more related terms, a validation indicator, or a reference code. In some aspects, the input can be imported and exported, either in an XML format or an Excel format. The input can be configured to be locked from editing once stored in the data store.

In another aspect, a method comprises receiving, by a computing device, an input identifying a term and a definition of the term; generating, by the computing device, a globally unique identifier (GUID) that uniquely identifies the input; and assigning, by the computing device, the input and the GUID to a taxonomy tree, wherein the input and the GUID are assigned to a node within a hierarchy of the taxonomy tree. In one or more aspects, the method can comprise mapping the taxonomy tree to an ontology. The ontology can comprise a World Wide Web Consortium (W3C) format, a JSON format or an Industry Foundation Classes format. The W3C format can comprise a Web Ontology Language (OWL) or Resource Description Framework. The W3C format can comprise a NTriples format, JSON-LD format, NQuads format, Turtle format, or TriG format.

In various aspects, the method can comprise input in a data dictionary, wherein the stored input is identifiable by the corresponding GUID. The stored data, taxonomy and ontology can be locked after validation. The taxonomy tree can be stored in a data store in Excel or XML format, wherein the stored taxonomy tree can be configured for bi-directionally conversion between Excel and XML formats. The input can be imported or exported in either in XML or Excel format. The input can further identify at least one of a source of the term, a date of when the definition was created, an abbreviation of the term, one or more related terms, a validation indicator, or a reference code. The hierarchy can comprise one or more sub-nodes, the one or more sub-nodes sharing one or more attributes with the node.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

For a more complete understanding of the embodiments and the advantages thereof, reference is now made to the following description, in conjunction with the accompanying figures briefly described as follows:

FIG. 1 shows an example of a main user interface of a taxonomy editor, in accordance with various aspects of the present disclosure.

FIG. 2 shows an example user interface illustrating the main components of the taxonomy editor in accordance with various aspects of the present disclosure.

FIG. 3 shows an example user interface illustrating an “Add New Term” form of the taxonomy editor in accordance with various aspects of the present disclosure.

FIG. 4 shows an example screen capture of a DataSet template for a Microsoft Excel spread sheet in accordance with various aspects of the present disclosure.

FIG. 5 shows an example user interface illustrating an “Add Node” form of the taxonomy editor in accordance with various aspects of the present disclosure.

FIG. 6 shows an example exported taxonomy that includes data requirements for validation in accordance with various aspects of the present disclosure.

FIG. 7 shows model development stages in an AASHTO/NSBA Collaboration Standard or Guide in accordance with various aspects of the present disclosure.

FIG. 8 shows an example “Ballot Closed” message in accordance with various aspects of the present disclosure.

FIG. 9 shows an example flow chart of the development of standards of the AASHTO/NSBA Steel Bridge Collaboration in accordance with various aspects of the present disclosure.

FIG. 10 shows an example screen capture of the Merriam-Webster Online Dictionary for the term “Bridge” in accordance with various aspects of the present disclosure.

FIG. 11 shows an example screen capture of the AASHTO LRFD Bridge Glossary in accordance with various aspects of the present disclosure.

FIG. 12 shows an example taxonomy hierarchy in accordance with various aspects of the present disclosure.

FIG. 13 shows an example structure of a BrIM ontology in accordance with various aspects of the present disclosure.

FIG. 14 shows an example structure of an ontology in relation to a taxonomy and dataset in accordance with various aspects of the present disclosure.

FIG. 15 shows an example portion of the BrIM Data Dictionary developed by Hu in accordance with various aspects of the present disclosure.

FIG. 16 shows an example of an inverse axiom relation in accordance with various aspects of the present disclosure.

FIG. 17 shows an example structure of OWL 2 ontology in accordance with various aspects of the present disclosure.

FIG. 18 shows an example representation of individuals of a Bridge domain in accordance with various aspects of the present disclosure.

FIG. 19 shows an example representation of the intersection of steel and bridge in accordance with various aspects of the present disclosure.

FIG. 20 shows an example representation of the union of male and female in accordance with various aspects of the present disclosure.

FIG. 21 shows an example representation of non-disjoint classes in accordance with various aspects of the present disclosure.

FIG. 22 shows an example representation of inverse properties in accordance with various aspects of the present disclosure.

FIG. 23 shows an example representation of a functional property in accordance with various aspects of the present disclosure.

FIG. 24 shows an example representation of a transitive property in accordance with various aspects of the present disclosure.

FIG. 25 shows an example representation of a symmetric property in accordance with various aspects of the present disclosure.

FIG. 26 shows an example representation of a hasComponent in accordance with various aspects of the present disclosure.

FIG. 27 shows an example framework of ontology implementation into a software application in accordance with various aspects of the present disclosure.

FIG. 28 shows a sample of BrIM ontology in accordance with various aspects of the present disclosure.

FIG. 29 shows sample property restrictions of a project in accordance with various aspects of the present disclosure.

FIG. 30 shows sample property restrictions with cardinality in accordance with various aspects of the present disclosure.

FIG. 31A shows an example of a BrIM ontology integration in accordance with various aspects of the present disclosure.

FIG. 31B illustrates examples of words and usage in a BrIM data dictionary in accordance with various aspects of the present disclosure.

FIG. 32 shows a schematic block diagram of an example of a computing device, in accordance with various embodiments of the present disclosure.

### DETAILED DESCRIPTION

A taxonomy can be defined as a hierarchical structure of terms that represent the relationships and attributes among those terms. A well-established taxonomy can be an imperative first step in defining an ontology to promote interoperability. In other words, defining terminology upfront can help seamless information exchanges at the end user (e.g. software). There can be two reasons contributing to this conclusion: 1) the industry experts that define the terminology may not have the technical skills to build an ontology, and 2) ontology development is quicker for software developers when they have the terminology in front of them, versus having to research how to define the terms. Having a well-established taxonomy will help clear semantic issues since each term used will be balloted, approved, and become the official term definitions. This means all software that use the taxonomy (via the ontology) will refer to the same term (definitions, properties, attributes etc.), thus eliminating the semantic confusion. Therefore, before a bridge information modeling (BrIM) ontology can be developed, for example, common definitions and concepts would need to be defined and classified in a taxonomy. Accordingly, an ontology can be defined as the highest (abstract) level for a domain that describes the objects, concepts, and relationships between them that hold in that domain.

Information exchanges to support critical business workflows are important aspects to achieving interoperability. Establishing standard definitions for information exchanges are beneficial for reuse, which may require a standardized process to do so. The National BIM Standard (NBIMS) is one example of an information exchange standard for standardizing information exchanges. However, NBIMS is limited to only the building industry as the only output is industry foundation class (IFC). A current IFC release (buildingSMART, 2015b) does not include bridges, and thus the NBIMS cannot be used for bridge information modeling (BrIM). Therefore, it is beneficial that there be an information exchange standard that does not rely on a single schema, but also allows a user (or software vendor) to choose the schema. Not only will this be significant for BrIM, it will allow for other industry domains to use it as well.

Organizing captured information into a usable format that can be passed and modified, similar to the NBIMS design, may be beneficial. Unlike the NBIMS where the information exchange is compiled into Model Views (subset of the IFC schema), embodiments of the present disclosure allow information to be organized into a taxonomy, which can be non-domain specific. For example, if IFC is chosen as the schema, the Model Views can still be created based on the information in the taxonomy. Model views still require the domain knowledge to be identified and documented, which the taxonomy does provide. Therefore, not only does a taxonomy not require any more additional time to create than a Model View, it can actually save time and effort by its reuse capabilities.

Current approaches that only use electronic forms of communication run into inefficiencies such as rework, version control, and loss of information. One example of inefficient communication is an email chain. Keeping track of comments and information in an email chain is difficult, and information is often overlooked. A commonly used tool to capture information is a programmable spreadsheet (e.g., Microsoft Excel). Spreadsheets can be effective if proper version control, document updates, and organizations are maintained. However, this process is typically done manually, resulting in wasted time. Therefore, a semi-automated approach is presented to help minimize the manual processes that result in errors and inefficiencies in accordance with various embodiments of the present disclosure.

The end format of the information exchange standardization (IES) is an ontology, which can be converted into any schema or used directly by software vendors. However, before an ontology can be developed, the domain information needs to first be captured in a taxonomy. In order to maintain proper format and help automate the capturing of domain knowledge, various embodiments of the present disclosure utilize various functions to automate the manual tasks associated with creating a taxonomy. Further, utilizing the domain knowledge already captured in a process model can drastically reduce the time and effort spent gathering the information. Additionally, a well formed taxonomy models the domain, and thus can be reused for other use cases.

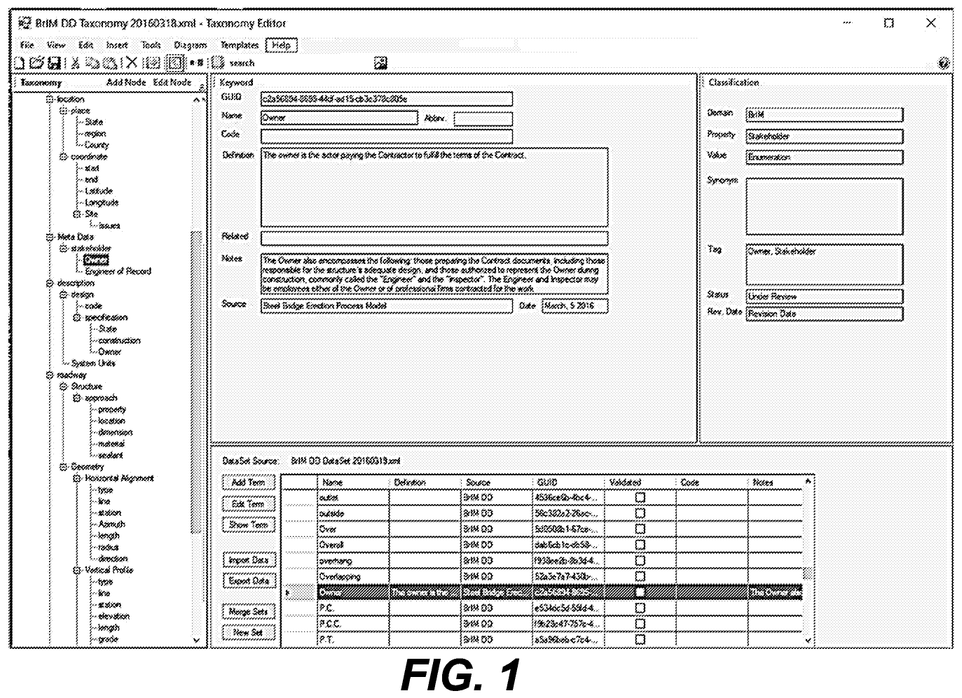

According to various embodiments disclosed herein, a taxonomy editor helps automate the construction and organization of a taxonomy. The taxonomy editor utilizes various functions and proprietary algorithms to automate the manual tasks associated with creating, modifying, and exporting a taxonomy. Further, the taxonomy editor helps automate the process of capturing and putting domain knowledge into usable forms. For example, FIG. 1 shows an example of a main user interface of the taxonomy editor with the term “Owner” being displayed. As an example, the taxonomy editor may be programmed in C# using Visual Studios.

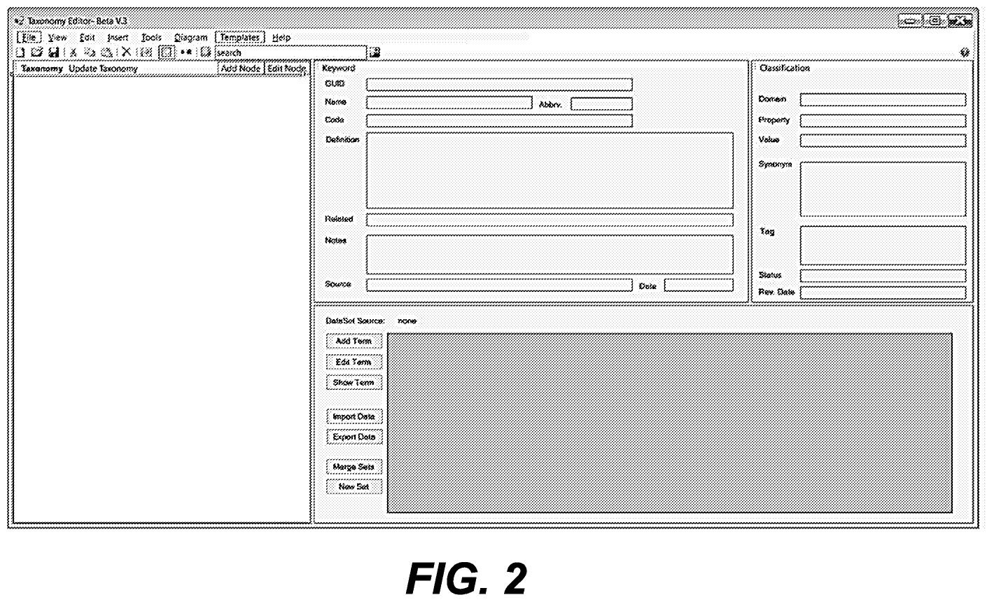

The taxonomy editor can have two input/output documents referred to here as: DataSet and Taxonomy. The DataSet can be an XML formatted dataset of all terms. For example, it may serve essentially as a dictionary of the components that are used to populate the taxonomy. The purpose of the DataSet, also referred to a Data Dictionary (DD), is to contain all the information of the domain in one central location, in which each term is identified by its globally unique identifier (GUID). Thus, any software or application that uses the DataSet will be linked to the main keyword. Multiple applications can link to the same keyword, and if the keyword is changed, it will be updated accordingly in the software (given that the software allows updates). The keyword, as shown in FIG. 1, shows the information about any term that has been selected in the taxonomy. FIG. 2 shows a user interface illustrating the main components of the taxonomy editor including the taxonomy, selected keyword, similar concepts, and DataSet.

Each keyword has a classification component to it. This represents any and all domains it currently belongs to, as well as the property type and value. A first aspect is the identification of synonyms. Similarly, to the function of a thesaurus, the synonyms identify any and all terms that assume the same definition (i.e., the same element). For example, in bridge engineering, a “wing wall” and “stem wall” are the same bridge element. The end user of the taxonomy can classify which is the default name of the element, and the others will appear in the synonym box. The second significant aspect is the identification of tags. Tags are user defined terms that are related to the keyword.

### Defining Terminology

Defining the terminology of the DataSet applies to the development of a DataSet. Once a DataSet has been approved by the domain, defining terms again would be unnecessary. However, exceptions may arise if new terms need to be added to the DataSet, or if the consensus of the domain determines that a term needs to be edited or modified. Therefore, the following steps explain how terminology is defined and a DataSet is developed.

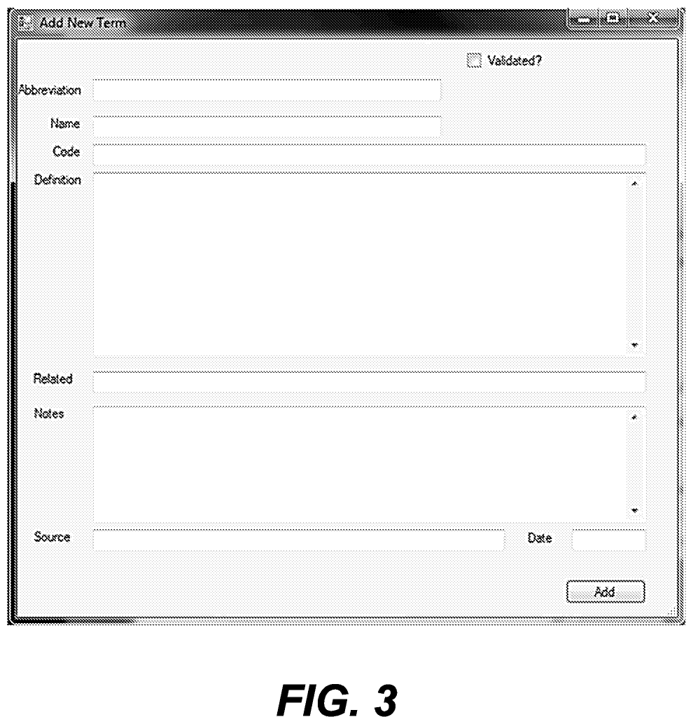

In a DataSet, terms represent the data and information that is needed to be exchanged in the process. The first step is to define each term, along with the definition and metadata. Terms can be defined in the DataSet in the taxonomy editor using the “Add Term” function (FIG. 2). Once the function is engaged, an “Add New Term” form will open (FIG. 3).

GUID: a new term may be tied to a GUID. The GUID is a computer generated (e.g., 128-bit) value to reference a unique value. Although, theoretically, there can be duplicate GUIDs referencing two different unique values, it's highly improbable. The purpose of the GUID is to be the identifier of that unique term. In the case of the BrIM taxonomy and ontology, a unique term (once balloted and approved) can be assigned a GUID that can be the reference to the term definition. Therefore, every application that uses that term can be referenced to the same term definition and attributes. This field can be left blank since the taxonomy editor can automatically produce a GUID.

Abbreviation: an abbreviation is a shortened form of the term. This can be used as a reference, as many words in the industry are referenced by the abbreviation, such as AASHTO (American Association of State Highway and Transportation Officials) or NSBA (National Steel Bridge Alliance). Abbreviation may be optional, and this field may be left blank.

Term: a term is the actual entity that the definition supports. Although “name” is often used, the word “term” is more appropriate since “name” is a description of what something is called. For example, instances of the term “bridge” may have names such as “Brooklyn Bridge” or “Golden Gate Bridge.” Term is an important field that should not be left blank.

Related: the related box is any other term that relates to the defined term. Having related terms are important for the meaning and use of the term. Related may be optional, and this field may be left blank.

Validate: validated is a Boolean (true/false) that signifies if the term has been balloted and approved. Once validated, the term will no longer be enabled for modification. Any modification would have to go through another approval process. Validated may be optional, and this field can be left blank (although once validated and approved it will be checked to prevent modification).

Reference Code: the reference code serves to be a reference to where the code is from. For example, MasterFormat and Omniclass reference numbers can be used to reference other definitions. However, the GUID is the main identifier. This field can be left blank, but it should contain the reference number if the term has one.

Source: the source is where the term is from. This is important for quality control. Many terms in the bridge industry are already defined and approved, such as those published by TRB or other organization bodies. Source is optional and this field can be left blank, but it is important to know where the term and its original definition came from.

Date: the date is important for quality control since terms may have been updated. The date goes hand-in-hand with the source. This can be in any format, e.g. “year,” “month, year,” and “month, day, year.” Date can be optional and this field can be left blank. However, if there is a source, it is important to have the date as a reference to when the source definition was created.

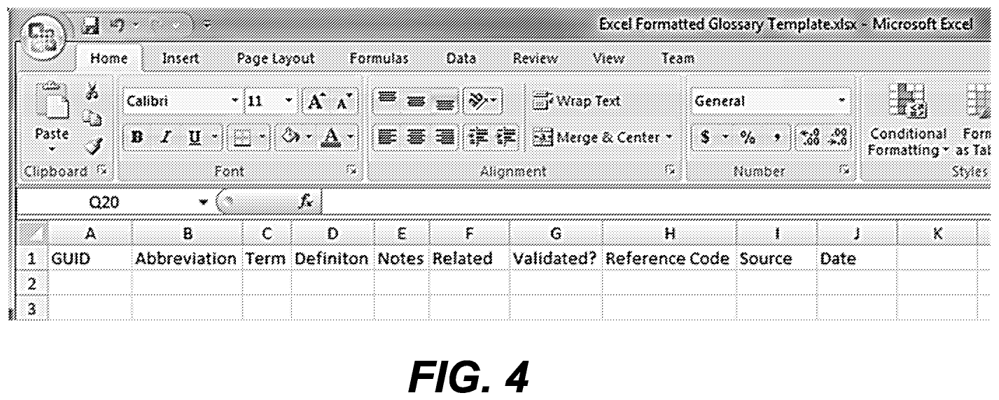

In addition to adding terms through the “Add Term” function, the editor has a template for an Excel spread sheet. The purpose of the template is to enable more flexibility in defining large subset of terms, including the “copy and paste” ability. As long as the spreadsheet columns are in the order as shown in FIG. 4, the editor can import the file and assign the terms into the DataSet (safeguards to verify the correct order can be incorporated). The editor can automatically assign the GUID, and once the term has been validated in the approval process, the GUID may be the same.

DataSets can be imported and exported using the editor, either in XML or Excel format among other formats. One significant advantage when important using Excel is that specific sheets can be select/selected. These two formats are listed as examples herein since they are both widely utilized, simple to use, and easily exchanged. Additionally, the editor makes the editing of the terms simple. According to an embodiment, once a DataSet has been validated and approved, the ability to edit the terms may be locked. The purpose of locking the terms is to prevent modification without further approval.

### Assigning Term Relationships

The basic format of a taxonomy is a hierarchy tree with a parent-child relationship. Each term, which is called a node, can contain sub nodes (children), and one super node (parent). This means that the node belongs to the parent, and the children belong to the node. This form allows for attributes of the parent nodes to be passed to the children. Additionally, further relationships can be added to add more detail.

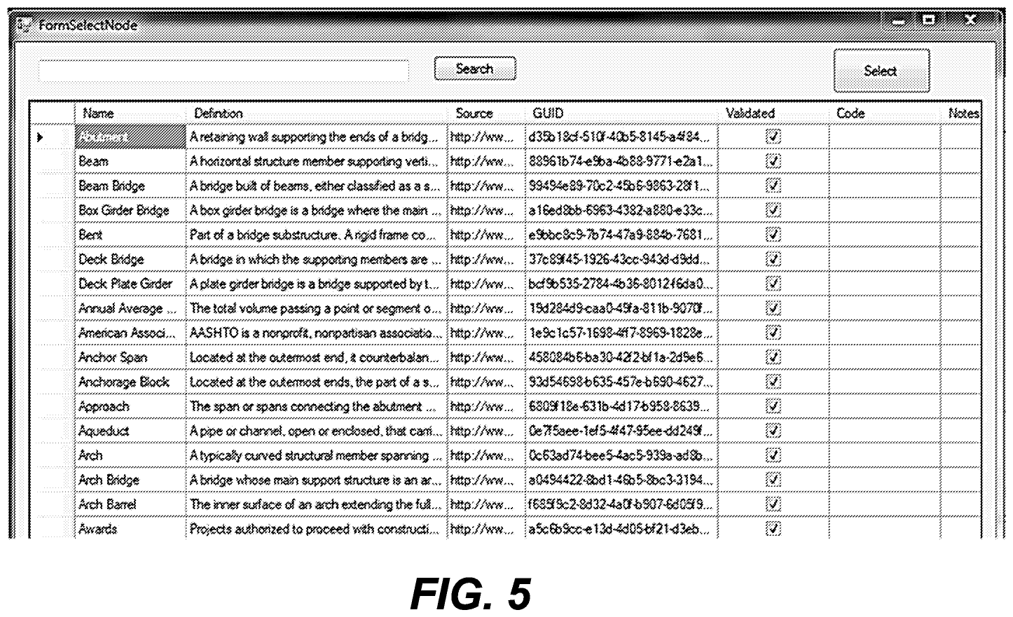

The taxonomy can be built by assigning terms from the DataSet to the taxonomy tree. Assigning terms to the taxonomy is simple by using the “Add Node” function, which is illustrated in FIG. 5.

Case Study: Organizing Steel Bridge Erection Knowledge into a Taxonomy: As a steel erection process contains many interactions and exchanges, one was chosen in order to be used as a test case for the development. The exchange model that was selected was the “Bid Model” and the exchange requirement is the data the Erector needs to prepare a bid. The assumptions are specified in section 6.1.5.3. The case study made use of the BrIM data dictionary. Additional terms and definitions were added that were needed for steel bridge erection. The BrIM taxonomy was created first based on the hierarchy of the BrIM Data Dictionary. However, the BrIM DD is constrained to four columns or levels: Information Groups, Information Items, Attribute Sets, and Attributes. The BrIM Taxonomy does not put any level constraints on the taxonomy. For this case study, the exchange requirement used the Data Dictionary to discuss and select the appropriate information. Next, the information was used in the development of the taxonomy and approval in the next step.

Design of Specification: Once the taxonomy is built with the associated DataSet terms, it can be exported for validation per each Exchange Requirement of the Exchange model. Additionally, the export template can be chosen by the user, including the user defined templates. The current method for validating is using Excel and assigning an “M” (mandatory), “O” (optional), or “N” (not required) to each data cell. The purpose of the assignment is to let the software vendors know what data is needed for the application. Since each receiver has different data requirements, it important for software functionality of the application.

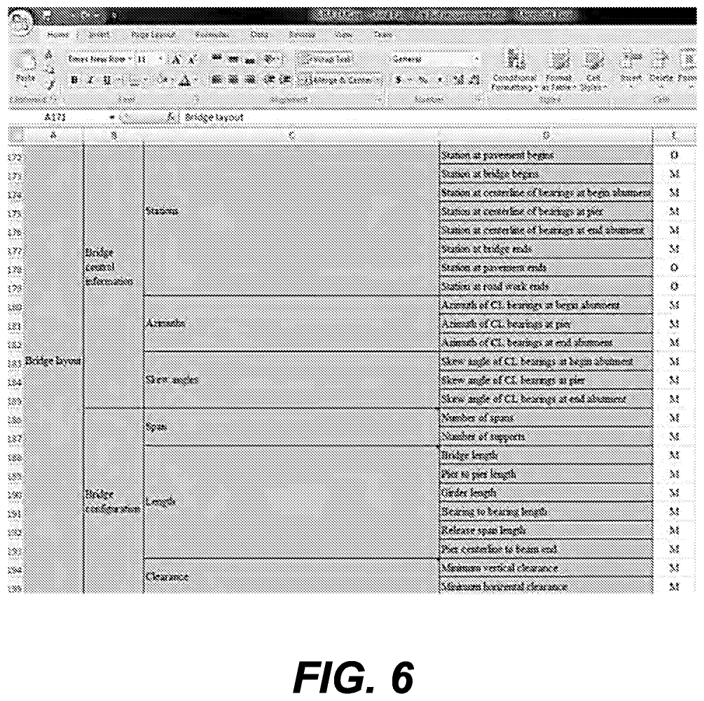

FIG. 6 displays the exported taxonomy with the data requirements for validation. It should be noted that the difference between the original Data Dictionary and the taxonomy exported Excel file is that the taxonomy has the GUID embedded and the cells are locked. This will prevent any modifications to the cell during voting and approval. Any comments or suggestion can be implemented by using the Excel “add comment” feature.

Balloting and Approval of Specification: In order for a standard or specification to be approved for official use, it typically goes through a balloting process. Since each domain industry may have its own process of approval, it is best to go that route. The timeline of this process will vary based on the official process that governs the domain group. The typical process is as follows:
1. Group members agree and finalize specifications
2. Group prepares documentation for ballot. If there is a hierarchy of the approval process, then the documents must be voted by any authoritative powers before final ballot.
3. Ballot is sent out to all committee members for commentary.
4. Any comments or suggestions are remedied in the ballot documents.
5. Ballot is sent for official vote. There may be specific rules of how the ballots are to be cast and counted
6. Upon successful ballot, the documents are approved for becoming a standard. If there are more levels of hierarchy, the ballot will keep being sent until the highest power approves.
7. Specifications will be designed into the official specification format.
8. Specification will be published.

AASHTO/NSBA Approval Process: The Erector exchange requirement for the “Bid Model” was modeled after the hierarchy of the Data Dictionary since it was the first model. Utilizing the Data Dictionary model has proven a success in the data requirement. Exchange requirements can include adding the ability to assign the “M” “N” or “O” requirement directly into the Taxonomy Editor. As mentioned before, the development of the editor was minimal to meet the needs of the group, and so further development is needed for full functionality.

The balloting and approval process for the AASHTO/NSBA can be found in the National Steel Bridge Collaboration operations manual. Below summarizes the process of becoming an Official AASHTO/NSBA Collaboration Standard or Guide Specification.

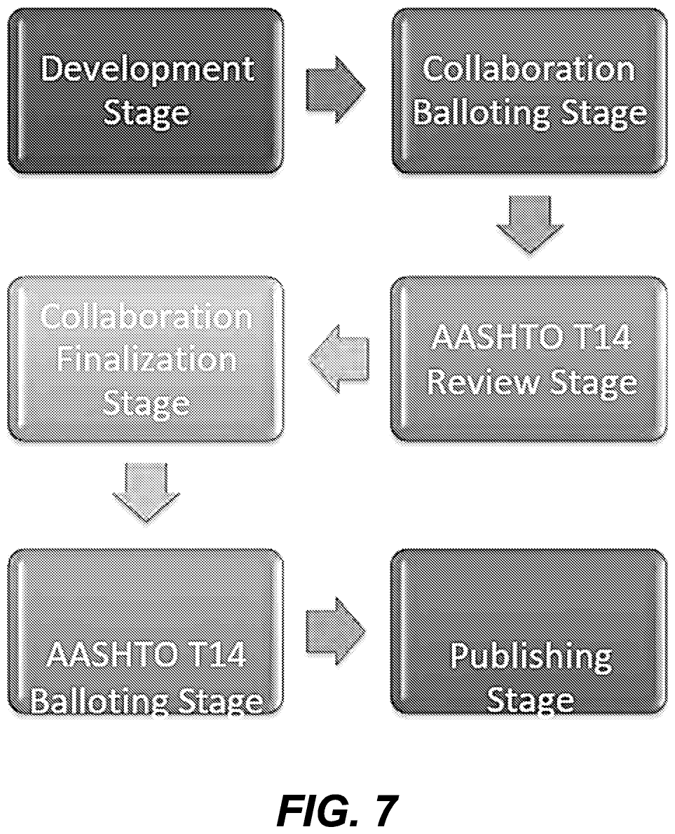

Becoming an Official AASHTO/NSBA Collaboration Standard or Guide Specification: The following document outlines the stages from the development of a Collaboration Standard or Guide to its final publishing by American Association of State Highway and Transportation Officials (AASHTO). Each stage is shown in FIG. 7. A document should be entirely finished and in final condition before it is submitted to the AASHTO T14 subcommittee in charge of steel bridges, Balloting Stage at the annual AASHTO Subcommittee on Bridges and Structures (SCOBS) meeting. The AASHTO SCOBS meeting occurs once a year either in the spring or early summer. The development, balloting, review and finalization stages must be completed in a timely manner to ensure publishing of a Collaboration document in a specific year.

Development Stage: At this stage an existing Collaboration document is being updated. Updates would include those that reflect current practices which may not have been captured in the previous revision. It may also include correction to errors and/or omissions that were discovered after initial publishing. Lastly, updates may include improved or expanded upon content. Note that a new Collaboration documents will also go through a development stage. During the development stage, the Collaboration document has only been typically reviewed by members of the specific Task Group that developed it. Once the document has been finalized, the document is then moved to the “Balloting Stage”.

Balloting Stage: When a Collaboration Task Group Chair has finalized all updates and changes to their document, the document is then readied for balloting by the entire Collaboration. This stage is intended to provide Collaboration members beyond that of the document's task group time to review and provide their comment. While this ballot is not intended to include AASHTO T14 members, there may be instances where a person is a member of both the AASHTO T14 and the Collaboration. Note that the document to be balloted should be given to the NSBA Collaboration Administrator as both a Microsoft Word file and an Adobe PDF. Only the PDF version of the Collaboration document will be provided with the ballot. The ballot will be administrated by the NSBA Collaboration Administrator.

Each person submitting a ballot is asked to vote in one of three ways:
1. Approve—I accept the balloted item(s) in full.
2. Approve with comment—I accept the balloted item(s) with the technical comments shown in the next section. I acknowledge that my comments may not be incorporated into the document and therefore I find the balloted item acceptable even if my comments are not incorporated.
3. Do not approve—I do not accept the balloted item(s) for the reason expressed in the next section.

It is expected that comments should be provided by the person submitting the ballot if voting either “Approve with comment” or “Do not approve”. Comments can be organized in a Google Spreadsheet where each row represents a specific section reference to the document being reviewed. It is expected that comments should be provided by the person submitting the ballot if voting either “Approve with comment” or “Do not approve”.

During balloting, any questions related to the document being balloted will be directed to the specific Task Group Chair. Any technical issues related to the operation of the ballot itself will be directed to the NSBA administrator. All ballots are administered and submitted online using a combination of Google Survey Form and Google Spreadsheet. Ballots may be open anywhere from 2-weeks to 1-month. At the conclusion of the ballot, the comments are then compiled and considered by the Task Group Chair.

There may be instances where a particular person is unable to access the online ballot form. In cases like these, an alternative submission method is provided using email. All emailed ballot responses should be sent to the NSBA Collaboration Administrator who will manually add them to the other ballot responses that have been submitted so that all responses are all in one location. The final date to submit a ballot response and comments by email will be the same date that the online ballot closes.

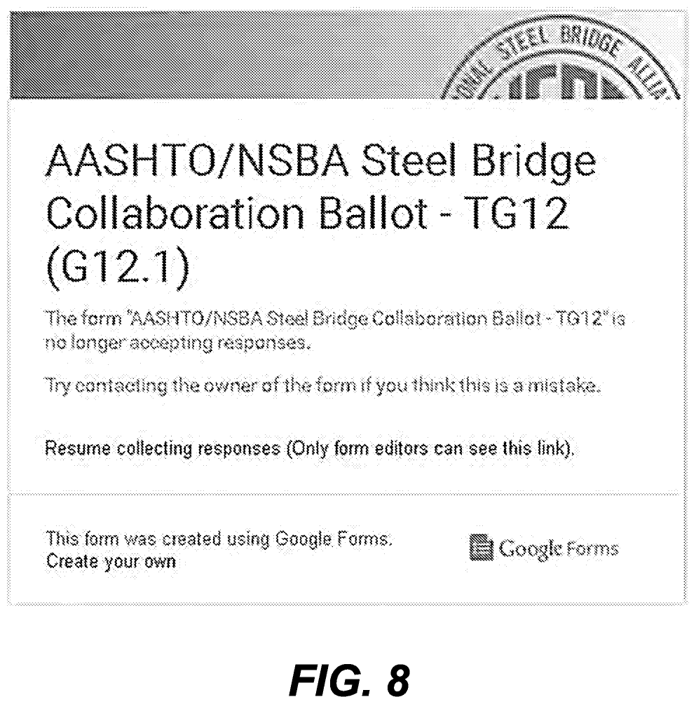

As previously stated, ballots are open for response for a fixed amount of time. At the end of this time, the ballot is closed and no additional responses are allowed. A ballot is closed by disabling the online form and denying access to the comments Spreadsheet. Anyone trying to access a closed ballot will encounter a message similar to that shown below in FIG. 8. At the conclusion of the ballot, the Collaboration Task Group Chair then reviews the ballot votes and comments. Any document that has received a majority “Do not approve” should be reconsidered before being forwarded to the AASHTO T14.

It may make sense for the Task Group Chair to address comments or changes regarded as “significant” before the document is submitted to AASHTO T14. Once the document has been “approved” by ballot, it is then moved to the “AASHTO T14 Review Stage”.

AASHTO T14 Review Stage: At this stage, a Collaboration document has been balloted by the entire Collaboration and has received a majority “approved”. The document is then provided to the member of the AASHTO T14 for review and comment. Review and comment will be handled similar to the balloting process so that all comments can be collected in a single location.

The AASHTO T14 members are given approximately 1-month to review and provide comments on all documents. All comments are compiled by the Task Group Chair and then reviewed by the corresponding Task Group who will decide how to best respond to the comments. Ideally, the processing of comments will happen before the next Collaboration meeting where the document will be finalized.

Collaboration Finalization Stage: At this point, a Collaboration document has been reviewed and commented on by both the entire Collaboration and the AASHTO T14 members. The Collaboration Task Group Chair will assemble all of the comments for discussion at the next Collaboration meeting. The Task Group may choose to incorporate or not incorporate comments at this time. It is important to understand that at the end of this stage, the final document submitted to AASHTO SCOBS will be automatically forwarded to AASHTO for publishing if approved.

AASHTO T14 Balloting Stage: Before a document can be published, it must go through the AASHTO T14 Balloting Stage at the annual AASHTO SCOBS meeting. The document is first put to vote by the AASHTO T14 members for approval. If a move is made to approve the document, a recommendation is made to forwarding to document to the SCOBS Main Committee. The SCOBS Main Committee will then vote to approve or reject the document for publishing. Note that the document to be reviewed at AASHTO SCOBS should be given to the NSBA Collaboration Administrator as both a Microsoft Word file and an Adobe PDF file. Both files will be provided to the AASHTO SCOBS main committee by the NSBA Collaboration Administrator.

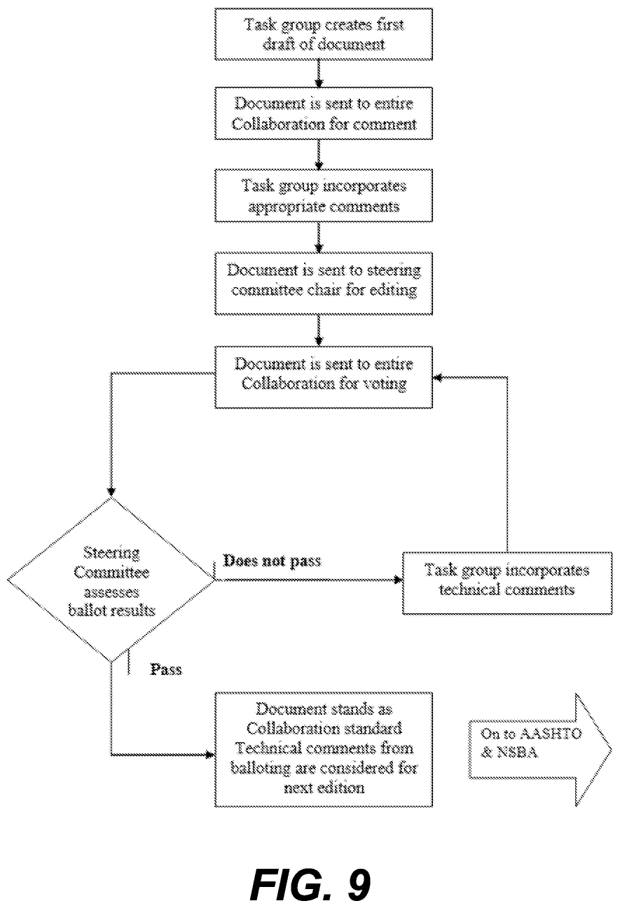

Publishing Stage: A document at this stage has been approved by the entire AASHTO SCOBS committee and has been forwarded to AASHTO for publishing. The final file format for a submission for publishing should be a Microsoft Word DOC or DOCX file and an Adobe PDF file. Any images used in the document should be available in a high enough resolution for publishing. In some instances, AASHTO may make a request for original images and figures. Collaboration Task Group Chairs should have all supporting images, figures and charts that are used in their document available in the event that AASHTO request them. These files should be provided to the NSBA Collaboration Administrator prior to the AASHTO SCOBS Review Stage. FIG. 9 represents the flow chart of the development of standards of the AASHTO/NSBA Steel Bridge Collaboration.

### Exporting Taxonomy and Additional Features

The taxonomy editor can use proprietary algorithms to bi-directionally convert the taxonomy hierarchy from Excel to XML formats among other formats. The taxonomy editor may also be tailored if special formats or headings in Excel are required (FIG. 5).

The taxonomy editor can further incorporate additional features and functionalities to further add to the automation of taxonomy development. For example, the taxonomy editor may automate the mapping from the taxonomy to an ontology, such as the Web Ontology Language (OWL).

Import/export formats. The import/export formats for ontologies include World Wide Web Consortium (W3C) formats for Semantic Web including Web Ontology Language (.owl), Resource Description Framework (.rdf), NTriples (.nt), JSON-LD (.jsonld), NQuads (.nq), Turtle (.ttl), and TriG (.trig). The import/export for other schemas include JSON (.json) and the Industry Foundation Classes (.ifc), which is an open standard for building information modeling (BIM).

Functions. The user can create and modify property attributes to assert on elements of the taxonomy. These attributes can be imported and exported with the taxonomy. The taxonomy can be easily organized using, e.g., drag-and-drop with the mouse. When exporting the taxonomy, users can define prefixes and namespaces. This can enable the users to ensure that the data can be merged with other documents and parsed by the computer. The user can import the full IFC reference schema and map entities 1-to-1 with the taxonomy. This can allow the user to identify where each element of the taxonomy can map into IFC. This allows the users to determine which taxonomy entities cannot be defined in IFC and then be created as a property set (PSET). In various implementations, the system can integrate with the buildingSMART International Data Dictionary bSDD. This can allow users to create and modify content as part of the bSDD. This also allows users to utilize content of the bSDD in their taxonomy. This is one example of using the import data set.

According to another embodiment, the taxonomy editor may support direct mapping to other schemas, such as the industry foundation classes (IFC). For example, the DataSet may be dragged and dropped into a taxonomy. The taxonomy may then be converted to an ontology using converts such as HML and excel. The HML format could then be converted into the IFC standard, such that software developers may be able to develop bridge software. End users that design buildings could provide consistent data to fabricators no matter the version of software that was used since the taxonomy can be based on the same ontology (HML) input. In such cases, the IFC schema (publicly available for use) can be loaded into the taxonomy editor. Consequently, new functionalities may then be encoded to parse the schema and populated entries into a user-friendly table in an organized manner. A user may then be able to select the IFC entity (e.g., “drag and drop”) onto the current term of the taxonomy. When the mapping is complete, it may be saved and/or exported.

There are a variety of Industry Reference Codes (e.g., Omnicalss, Masterformat) that either have application programming interfaces and software development kits available for public use. These Industry Reference Codes may be utilized to assign the appropriate codes to the data to maintain consistency.

### Taxonomy and Ontology Development

According to various embodiments of the present disclosure, a novel method of creating an ontology based on domain workflows is presented. The ontology development process in the disclosed method is different from the other processes since it emphasizes that the taxonomy is an imperative first step. It utilized the information and knowledge produced by the Information Exchange Standardization process identified previously.

A taxonomy and ontology are very similar, and in a non-technical sense can be difficult to distinguish. In order to clarify the difference between a taxonomy and ontology, below is a recap and illustration of how they are used.

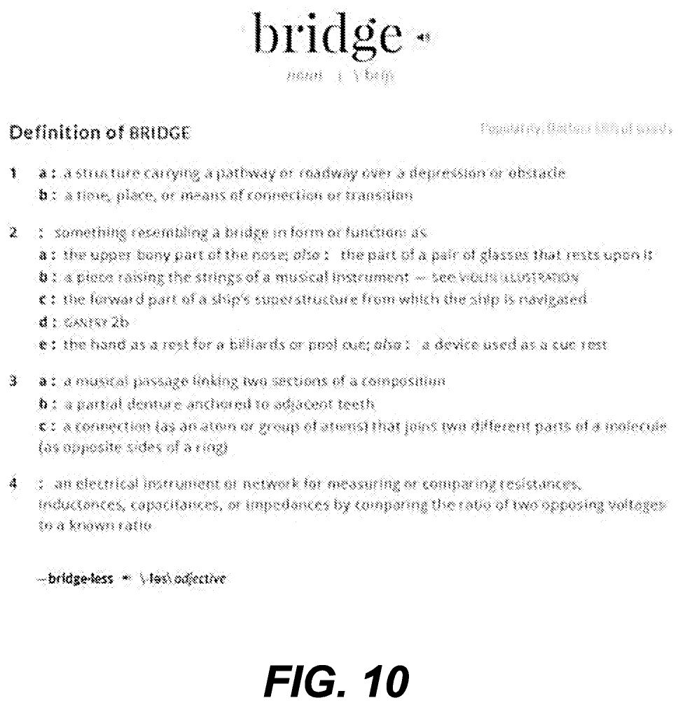

Dictionary: A collection of terms with definitions and examples of use. Additional information about the terms (origin, phonetics, grammar, etc.) may be included. Dictionaries comprise a wide variety of words, often spanning a wide variety of terms. Moreover, each term contains all the definitions and uses to the particular word, such as the term “bridge” shown in FIG. 10.

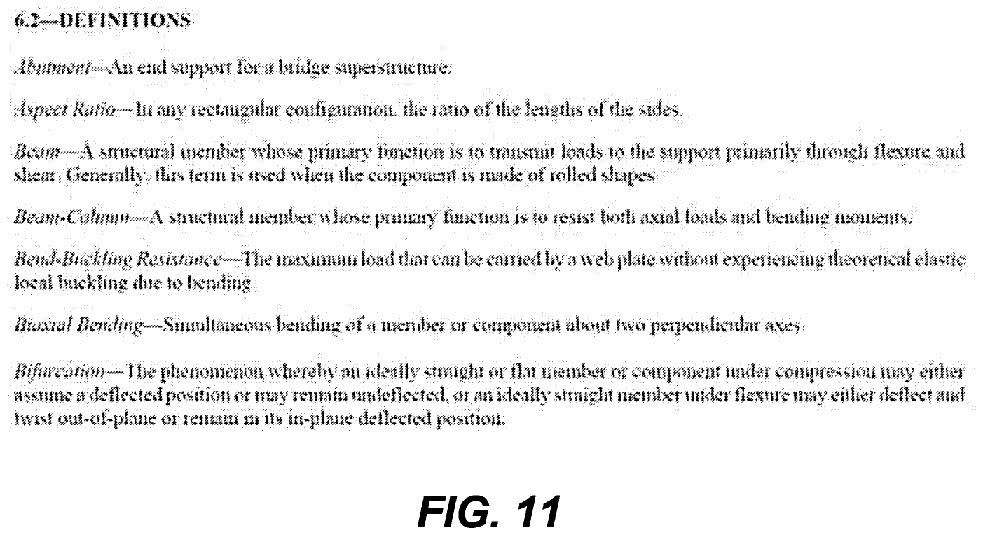

Glossary: A collection of specialized terms used in a particular domain, often found at the end of a chapter of a publication. A glossary defines the meaning of the terms that applies to that specific publication or domain. Some terms may have a “refer to” another term instead of a definition. A glossary differs from a dictionary in the fact that it only contains the definition of term, but it is the correct definition of how it is used in context. This can be beneficial when terms have multiple meanings for different domains. FIG. 11 displays a portion of the glossary from AASHTO LRFD.

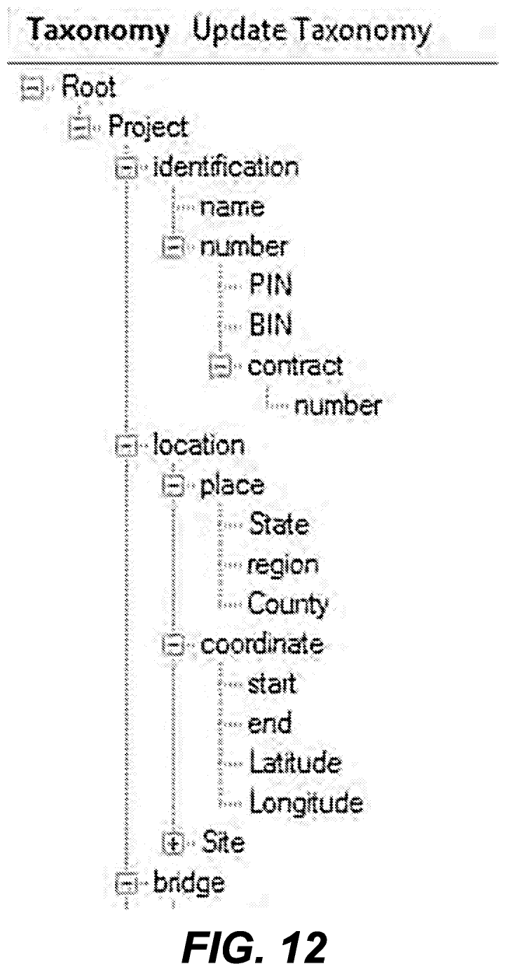

FIG. 12 displays an example BrIM taxonomy hierarchy. As stated previously, a taxonomy can represent a hierarchical structure of defined terms that represent the relationships and attributes among those terms. A taxonomy can essentially be the combination of a glossary and dictionary (since it's a subset of terms from a domain with definitions) in a hierarchical form to represent and display the relationships between the terms. It is important that the definitions should be validated and approved from the domain. A taxonomy can be in machine readable form (such as a spread sheet), but it may not contain the appropriate constraints and axioms that are needed to develop into software.

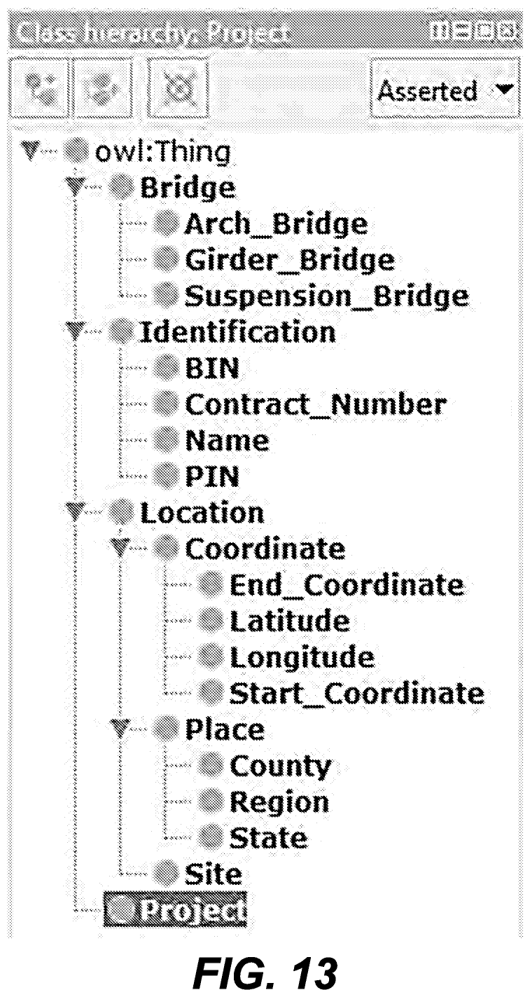

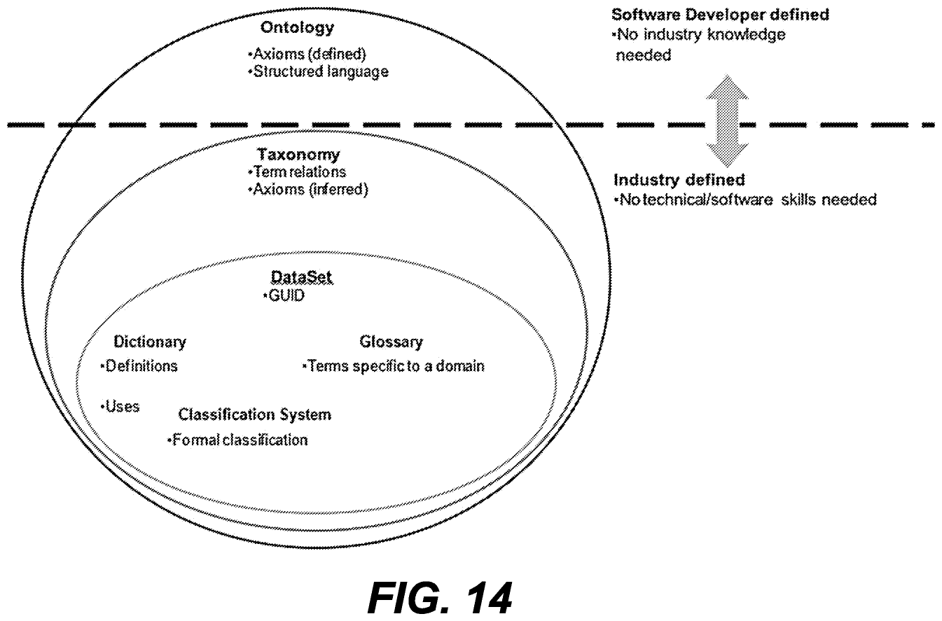

Ontology. In computer and information science, an ontology is the formal classification of entities in a particular domain, that includes the types, properties, relationships, and other attributes about the entities within the domain. FIG. 13 displays a subset of the BrIM ontology. A taxonomy with additional constraints (via axioms) can create an ontology. A well-formed ontology provides both the semantic (meaning) and syntactic (form) of information that can be used in software. The taxonomy provides the information and basic structure to convert into an ontology, which is the machine readable logic structure that can be implemented into software. It should be noted that the DataSet and Taxonomy are also both machine readable, which allows the information sharing, but they do not contain the logic structure needed by software implementation. The logic structure contains the additional axioms (logic assertions) provided by the ontology language in a common form (structure). FIG. 14 displays the structure of an ontology in relation to a taxonomy and DataSet.

An aspect of the disclosed embodiments is that the ontology is built from the bottom up (e.g., the domain workflow defines the structure of the ontology). This is important because domain experts, who may not have technical or software skills to develop an ontology, are able to define the taxonomy based on the workflow. Additionally, a well defined taxonomy can be implemented into an ontology by software developers, who may not be knowledgeable in the industry domain. Together, both industry experts and software developers can collaborate together to verify that the final ontology represents the domain knowledge. Note that not all current ontologies contain the definition or reference to a term that has been defined. This is one of the reasons that it is imperative to base an ontology on a taxonomy of validated terms to guarantee that the meaning and use of a term will be consistent.

Building a taxonomy prior to the physical development of the ontology is an imperative first step because a well defined taxonomy:
1. Reduces ambiguities of the domain lingo. Compiling a list of definitions in a domain will result in ambiguities since there may be synonyms of words. In other words, the same definition might apply to two different words. For example, joist, lintel, girder, plank, rafter, and purlin are all synonyms of the word “beam,” which is defined as “a structure member designed to carry loads between or beyond points of support, usually narrow in relation to its length and horizontal or nearly so” (ISO 6707-1:2014). Therefore, it may be imperative that the most commonly used term will be the default, and each synonym be accurately described for the function. Having clear and concise definitions, while using that same term definition across the domain will reduce the ambiguities.
2. Clarifies the semantics of terms. Likewise, with the same definition applying to different words, one word may have multiple definitions. For example, the word “bridge” can mean a ship's platform, a cue in pool, the top of a nose, an electronic component, a card game, or a structure. Approving one definition that fits the best need to that domain to will reduce the semantic issues that may arise from multiple meanings.
3. Provides consistency of terminology. Having a defined set of terminology will be the center of usage in software. For example, a “beam” in application A will always have the same definitions as “beam” in application B if they link to the definition in the taxonomy via the GUID.
4. Reduces time and effort in building a ontology. Industry experts, who may not be technologically savvy, can easily provide the information for producing the taxonomy. Therefore, once a well defined taxonomy is developed, the development of the ontology will be less cumbersome to develop, since all the information is needed (e.g., purpose, objective, competency questions, terminology, and relationships) to develop the ontology. Essentially, all that's left is to incorporate more axioms and convert the information into an ontology language, which puts fewer burden on the software developers to collect and verify domain knowledge. Although a considerable amount of time is placed in the taxonomy development, time and effort are not wasted verifying the terms from domain knowledge as in the case of traditional building of an ontology.

The following describes how an ontology is developed from the technological perspective. This process identifies the needs of a specific domain, in which the ontology can then be developed from. Moreover, the focus is not on solely creating the ontology, but how the ontology can be developed to fit the needs of the domain. In other words, the focus is not only the “end” result, but also can include the “means” needed to get to the end. This focusing on the workflow needs instead of the ontology needs is a novel contribution. The ontology is the final result of the process. For example, an ontology should not be created first and then determine what applications it has, but rather create the application and select the terms needed to be in an ontology. The steps of the ontology development are as follows:
1. Identify the purpose and requirements of the workflow;
2. Identify the terms used in the workflow;
3. Review existing terminology and select best fit;
4. Assign the terms into a taxonomy;
5. Define axioms to support the taxonomy;
6. Convert taxonomy to ontology;

### Step 1: Identify the Purpose and Needs of a Domain

An ontology can be viewed as the machine readable format for human knowledge. Since human knowledge is very extensive, it is important to identify the subset of knowledge that needs to be represented. The purpose and needs for the ontology can be determined in identifying the workflow for a specific domain. Instead of choosing the needs for the ontology, let the needs identified in the workflow justify the needs of the ontology. This subset of knowledge is determined in the IES Step 1. The scope of work should be determined in the workflow process. After a workflow has been developed, the task of exchange requirements will result in the data needed for this step.

Case Study: Identifying the Needs of Steel Erection: According to various aspects of the present disclosure, a purpose of the taxonomy is to classify all the terms and definitions needed to support BrIM workflows. The taxonomy may use terms in the United States, but would include all bridge types, including complex structures such as truss and suspension bridges. The taxonomy would also include those terms used in the transportation industry since it is expected that all geospatial and transportation models will need to be integrated. The taxonomy would be used in files and documents (e.g. manuals, contracts, bids, etc.) and software used in the bridge industry. A goal of the taxonomy is to standardize the vernacular and vocabulary of the bridge industry. The taxonomy will be used by transportation officials (e.g. state DOTs, FHWA, etc.), industry stakeholders (e.g. owners, contractors, builders, etc.), and BrIM software developers. The official body to manage and maintain the taxonomy is still undetermined, but is anticipated to be stewarded by an official organizing body, such as FHWA, AASHTO, or even buildingSMART International.

Even within a specific domain of use, such as the bridge industry, there are still a large number of terms to define and organize. Defining a scope will help narrow down the work and terms needed upfront. Since the taxonomy will be expandable, additional terms can be added as time progresses. Below are some questions to help develop the purpose and scope:
1. What sub domain is the taxonomy for?
2. What is the scope of the workflow?
3. What is the level of detail provided by the workflow?
4. What are the essential tasks that need the taxonomy?
5. What is a good starting point (i.e. the lowest hanging fruit)?

The aspects disclosed herein may work closely with the AASHTO/NSBA task groups in achieving various exchanges. The scope of this taxonomy can include bridge structures, specifically steel bridges. Even within steel bridges, there are various scopes of work. Further, research contributing to the aspects of this disclosure is partnered with the AASHTO/NSBA TG10-TG15, which deals with the erection of steel bridges. Therefore, the starting point of terms will deal with those needed for the erection and construction of steel bridges. Naturally, terms needed within this scope will expand and extend to a larger scope and domain. For example, the term “beam” will be need for steel bridge erection, but it may also be used in design of steel bridges, as well as concrete bridges and other structures.

### Step 2: Identify the Terminology Used in the Workflow

The taxonomy needs to be both expandable and extensible because it is infeasible to create a taxonomy that is complete and exhaustive of all terminology of a domain, especially as large as transportation and construction. The taxonomy needs to be expandable to incorporate more information as it grows, and also needs to be extensible to allow further development and incorporation with other domains. However, it is important to note that safeguards need to be in place to prevent such alterations of the taxonomy that would affect end user software development. For instance, an alteration in the taxonomy needs to be in the way that software developers can implement the alterations efficiently and effectively. The terminology can first be identified through the process model development, which is outlined in chapter X.

Case Study: Identifying Bridge Terms: The industry knowledge for the case study was captured in the “Outline of Typical Processes for Steel Erectors” document for the TG10-TG15 Work Group for Steel Erection Analysis Modeling. This document outlines the process that erectors follow in the construction of steel bridges. Then, the workflow was captured in the “Process Model Development for Steel Erection” document and its corresponding process map. A more defined narrative and instructions about the workflow and all of its parts are added. Similar to a glossary, all the terminology for the workflow are defined. Additionally, the data defined in each exchange was also captured. One of the first exchange requirements (ER) identified for steel erection in the AASHTO/NSBA TG10-TG15 was the “Contractor to Erection Engineer” ER. This exchange identifies the information and data needed by the erection engineer to in order to submit a bid.

### Step 3: Review Existing Terminology and Select Best Fit

In order to accurately define the domain, it is beneficial to use the terminology that is used in that domain. It is beneficial to use terminology that is commonly used in the specific domain in order to reduce ambiguities. One way to do so is to first gather and compile all published documentation in that domain, and then sort through similar terms. It is expected that either the same spelling of a term has multiple meanings, or multiple terms have the same definitions. Therefore, it may be required that these ambiguities and similarities be reduced by selecting the most appropriate term with the most appropriate definition, which then needs to be discussed with the domain experts. Finally, like everything else in the process, the compiled list of terms needs to be validated and approved by the domain. Since each domain may have different process, it is up to the experts (or appropriate organization) to determine the rules and procedures to approve the terms.

Case Study: Utilizing Existing Terminology in the Bridge Industry: The American Association of State Highway and Transportation Officials (AASHTO) is the official United States organization that publishes specifications and standards used in highway design and construction. Therefore, the AASHTO published terminologies (AASHTO, 2014) was selected first and may take precedence over other published terms. Other domain specific terminology, such as the NCHRP Steel Bridge Erection Practices (NCHRP, 2005), will need to be gathered to narrow down the terminology for each respective sub domain.

The terminology then may be sorted and organized. It may be expected that there will be multiple synonymous of a single term because terminology varies by organization, department, and region. Even within the same bridge project, there might be discrepancies of the terminology. An initial effort compiled bridge terms in an Excel file, called the BrIM Data Dictionary. In order to create one standard term, the synonyms would be complied and ranked by usage. Once agreed upon by the domain experts and balloted, a single term would be the default while the others would be listed (e.g., if a term that is not the default is selected, it would point to the default term to be used).

An initial effort compiled bridge terms in an Excel file, called the BrIM Data Dictionary. In order to create one standard term, the synonyms would be complied and ranked by usage. Once agreed upon by the domain experts and balloted, a single term would be the default while the others would be listed (i.e. if a term that is not the default is selected, it would point to the default term to be used).

Step 4: Assign the Terms into a Taxonomy

Once the terms have been organized, they need to be put in a hierarchy tree. It is important to utilize currently known hierarchies. The hierarchy development in itself is an iterative process. To accurately portray the real world, the hierarchy needs to be developed and approved by domain experts. Then, each term will be defined with its own GUID, and all properties and relations will be listed such as “part of,” “contains,” “synonyms,” “etc.” For the synonyms, it will be voted upon to have the most widely used term to be the default term, so when a person looks up a term it will be routed to the default term (this will help people use the correct term). The schematic will be hierarchical base with enumerations and exclusions (e.g., if a “beam” falls under one hierarchy, it may not have the same properties as a “beam” from another tree hierarchy, even though fundamentally they are the same GUID). This organization is important for neutral software development.

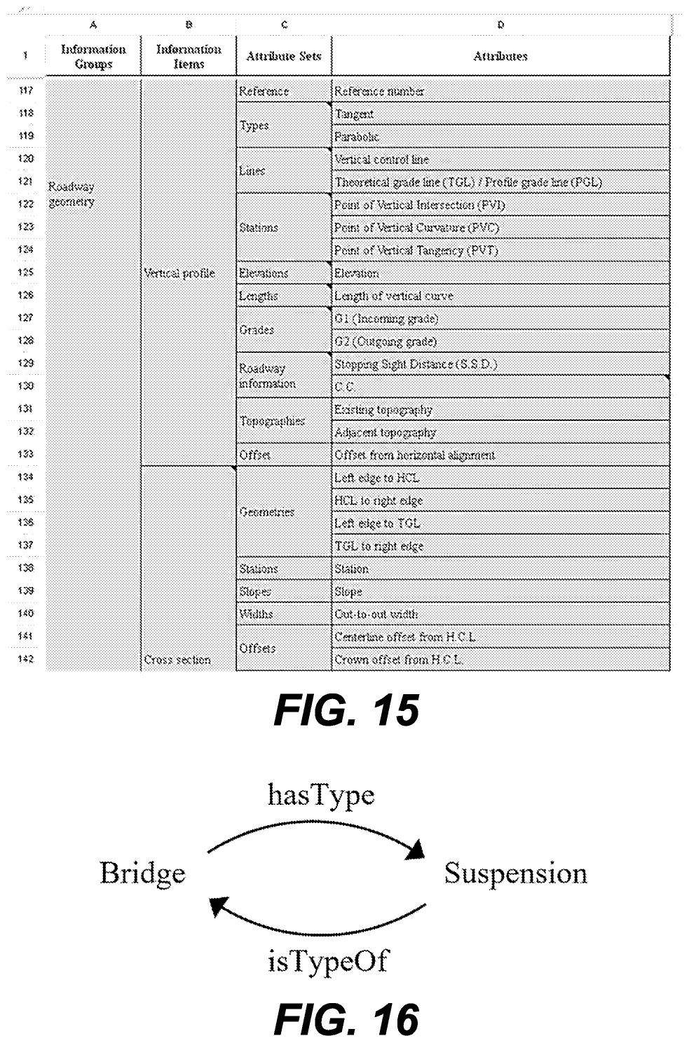

Case Study: Assigning Terms into the BrIM Taxonomy: The BrIM taxonomy makes use of the Data Dictionary. FIG. 15 shows a portion of the terms in the hierarchy. Assigning terms may be a difficult step of the taxonomy development because defining a term can be difficult at the fundamental level, most in part due to the amount of terms that may need to be defined. The first difficult question that needs to be asked is: what terms need to be defined?

Another factor is the “type of” or “enumeration” property. “Type of” defines a subset and “enumeration” means part of list. The second difficult question to answer is: how many levels of “type of” and “enumeration” will be sufficient to define the term? For example, take a bridge erector. An erector is “a person that erects something” and the AISC Steel Bridge Erection Guide (NCHRP, 2005) defines an erector as “entity that is responsible for the erection of the structural steel.”

The Data Dictionary comprises the hierarchy structure of the attributes and properties that have been identified in various exchanges of the bridge lifecycle. For example, a bridge requires roadway geometry, and thus “roadway geometry” has been identified as an information group. Roadway geometry has information items that describes the geometry, such as vertical profile and cross section. Then, each information item can be described by a varying attribute set. For example, the vertical profile attribute sets can include references, lines, stations, and elevations to name a few. Finally, each attribute set can be broken into more attributes and properties until the fundamental concept that describes a specific attribute is reached.

### Step 5: Define Axioms to Support the Taxonomy

According to various aspects, an axiom is a “stated rule or principle that helps govern the taxonomy and ontology.” Axioms are similar to postulates (e.g., math or geometry postulates), in which they are assertions without any formal proofs. However, these assertions are used for deducing other truths. As mentioned earlier, axioms are an important part of developing taxonomy because they provide truths and assumptions that give meaning to the taxonomy. Axioms can be seen as the most difficult part of this process because they are involved in providing the semantics of the taxonomy (and ontology). However, axioms should be treated as a double edged sword since overly constraining the taxonomy would impede extension and expansion. For instance, the axioms in the ontology should be minimally sufficient to express the competency questions and to characterize their solutions. Although this is stated for axioms for an ontology, this same principle applies to axioms for taxonomies.

Axioms are typically written out in first order logic. As part of mathematical logic, these types of rules are associated with type theory. Table 7-1 summarizes an example of the main notation in first order logic that may be used in the development of axioms.

TABLE 7-1
Notation of First Order Logic

| Symbol | Description | Meaning |
|---|---|---|
| Quantifiers | | |
| ∀ | universal quantification | “For all” |
| □ | existential quantifier | “there exists” |
| Operators | | |
| ∧ | conjunction | “and” |
| ∨ | disjunction | “or” |
| ¬ | negation | “not” |
| → | Implication/conditional | “implies”, “if . . . then” |
| ↔ | biconditional | “If and only if” or “iff” |
| Set Theory | | |
| ∈ | membership | “includes” |
| ∪ | union | “both” |
| ∩ | intersection | “overlap” |
| ⊆ | subset | “some or all” |
| ⊂ | proper subset | “some, but not all” |
| = | equality | “equals” |

The competency questions identified in the prior step specify the requirements that the axioms need to address. Below, Table 7-2 lists an example of some basic axioms and definitions needed in the development of a general taxonomy. From these, base axioms additional axioms can be defined.

TABLE 7-2
Definitions and Axioms

| Relations | Axiom | Definition | Example |
|---|---|---|---|
| ComposedOf | Composed-of (A, B) − | B is composed of A, if A | Bridge is composed |
| | (B⊆A) ∧ (A [symbol] B) | is a subset of B, and B | of smaller parts, e.g. |
| | | is not a subset of A | columns, beams, etc. |
| TypeOf | | Aggregation of types, | Steel is a type of metal. |
| | | such as material or | Metal is a type of material. |
| | | class | |
| PartOf | | Aggregation of | Beam is a part of |
| | | discrete, physical | bridge substructure |
| | | parts | |
| SubclassOf | | Classes that inherit | Suspension bridge |
| | | the parent class. | is a subclass of |
| | | | bridge. |
| InverseTo | ∀A, B f(A, B) ↔ | For all A and B, relation | If beam is partOf bridge, |
| | g(B, A) | g is the inverse of | then bridge hasPart beam. |
| | | relation if A maps to B | |
| | | and B maps to A. | |

Although axioms can be defined explicitly, inferred axioms can also be embedded in the development of the taxonomy, which are called inferred axioms. An inferred axiom is an assertion that is not explicitly defined, but rather inferred based on relationships. For instance, part-whole axiom, which can be referred to as aggregation, can be automatically assigned by placing terms under each node in the model shown below that depicts an example of aggregation (subclass axiom):

Model 1:

```
>Bridge
  >Suspension
  >Girder
  >Arch
```

For example, a user starts with a “bridge” class node, and then under that node is placed “suspension” type, “girder” type, and “arch” type. Inherently, the user created the part-whole axiom which reads, “suspension, girder, arch are types of [class] bridges.”

Axioms can further have inverse relations shown in FIG. 16. Keeping with the example above, “Bridge” hasType “Suspension” and the inverse relation would be “Suspension” isTypeOf “Bridge.” Although intended to be flexible to let the user to define the axioms, the Taxonomy Editor may comprise the aggregation axiom, in which an entity may not be composed of the same entity. In other words, a term may not be assigned in the same tree as itself. For example, “bridge” is a parent node, and if the same “bridge” entity is placed under it as a child, an error message may pop up notifying of the error.

### Step 6: Convert Taxonomy to Ontology

The previous section discussed the notation of first order logic and a few axioms needed to develop a taxonomy. In order to convert the taxonomy to an ontology, more explicitly defined axioms and properties are needed to provide the semantic meanings that a software needs. The major difference between the taxonomy and ontology will be the final output file and format. The ontology takes the hierarchical format of the taxonomy and explicitly defines the relationships between the nodes. Additional information is added using property features.

Although other ontology language can be used, aspects of the present disclosure utilize the Web Ontology Language (OWL) since it is the most widely used. Additionally, OWL is an ontology for the Semantic Web and intended to be used and shared over the World Wide Web. Therefore, having a widely used ontology enables the extensibility for easily sharing information in other domains. This section provides an overview of OWL 2 and the development of an ontology, but the full guide and development for the second edition of OWL (OWL 2) can be found at (W3C OWL Working Group, 2012). Additionally, an introduction to the syntax of OWL 2 can be found at (W3C, 2012).

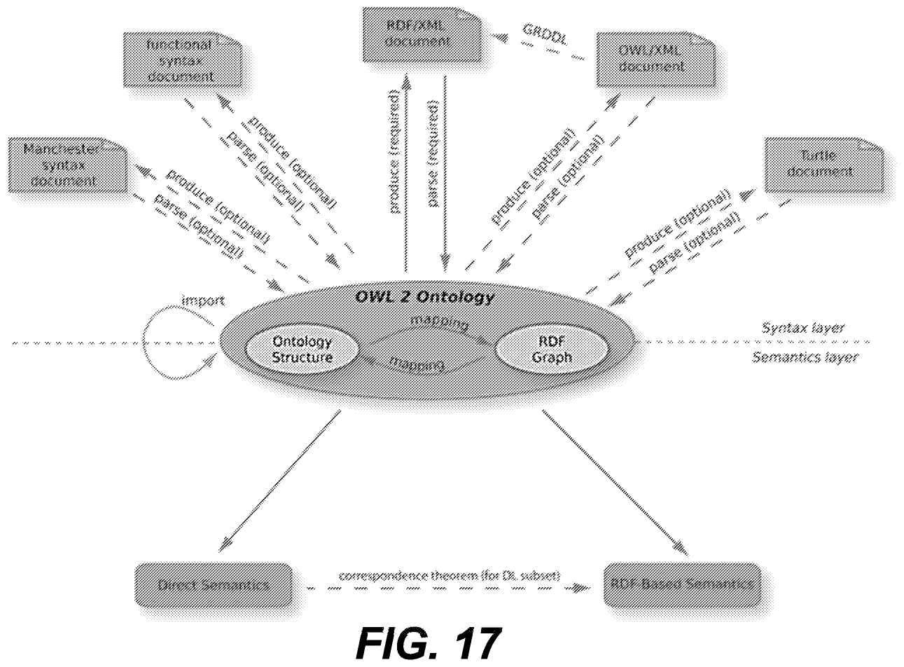

The overview of the structure of OWL 2 is shown in FIG. 17. At the core OWL 2 includes the abstract notion of the ontology and the structure of the language, which can be represented as the Ontology Structure or RDF (Resource Description Framework) Graph. The bottom half of the dashed line represents defining the semantics (meaning) of the ontology language, which can either be direct or RDF-based. At the top of the dashed line display the syntax (structure) of the ontology, which are needed to store and exchange the ontology. There are various available (and often free) tools and application that can develop the syntax of the ontology.

### Ontology Components

Like other ontologies, OWL 2 represents and exchanges knowledge by the use of three fundamental notations: axioms, entities, and expressions. Axioms are the basic statements that the ontology expresses, entities are the elements that represent the real-world objects, and expressions are the complex descriptions formed by a combination of entities. The major elements of the OWL ontology structure include Individuals, Classes, and Properties, which can be defined as Resource Description Framework (RDF) resources. For the sake of clarity, aspects disclosed herein will visually represent the objects by the following: “Individual” (quotations), Class (capitalized and bolded), and property (italicized with CamelCase).

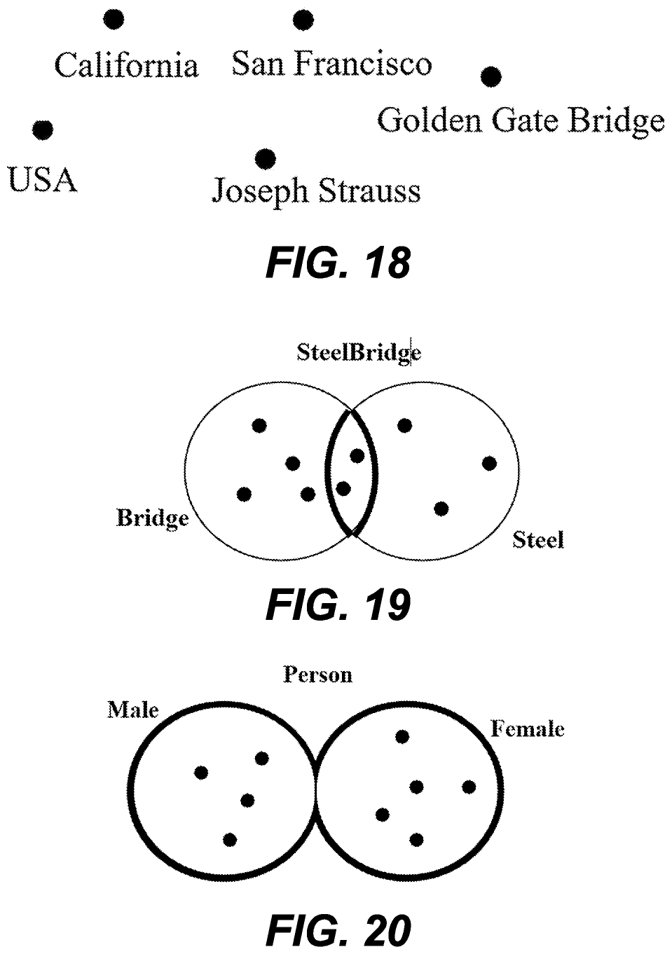

Individual: An individual represents a specific object in a domain. Individuals are also known as instances. In OWL 2, individuals are defined by “individual axioms”, which are known as facts. These facts are used to describe each individual, such as class membership, property values, or descriptions. FIG. 18 displays a representation of individuals in the bridge domain. For example, “California” is an individual of class State, “Golden Gate Bridge” is an individual of class Bridge and “Joseph Strauss” is and individual of class Designer. Note to not mistake an individual for a class (which is described in the next section). An individual is a single instance of a class, and thus there should only be one. For example, a beam would be considered a class, since there are many instances of a beam, and a “LMC1113” is the name (piece mark) of an individual of a beam.

Classes: The main building blocks of an ontology are classes, which group individuals with similar characteristics. In other words, a class is a set of individuals. In order to be a member of a class, an individual should satisfy the conditions that are set by those class descriptions. These conditions are what enable the distinctions of individuals. OWL 2 distinguishes six types of class descriptions (i.e. a class can be defined by):
1. A class identifier, which is a Uniform Resource Identifier (URI) reference, that it describes a class through a class name.
2. An exhaustive enumeration (i.e. list) of individuals that together form the instances of a class. The enumeration description is defined with the owl: oneOf property. Model 3 below is an example of an enumeration (in OWL syntax) of bridge types, in which an individual can be only one of the following: Arch, Beam, Truss, Cantilever, Suspension, or Cable-stayed.

Model 2:

```
        <owl:Class>
<owl:oneOf rdf:parseType=“Collection”>
      <owl:Thing rdf:about=“#Arch”/>
      <owl:Thing rdf:about=“#Beam”/>
      <owl:Thing rdf:about=“#Truss”/>
      <owl:Thing rdf:about=“#Cantilever”/>
      <owl:Thing rdf:about=“#Suspension”/>
      <owl:Thing rdf:about=“#Cable-stayed”/>
    </owl:oneOf>
  </owl:Class>
```

3. A property restriction that defines an anonymous class, which is a set of individuals that satisfy the restriction. This means that a class does not have to be explicitly defined to exist. A property restriction describes a class of individuals based on the relationships that members of the class participate in. In other words, an anonymous class contains all the individuals that satisfy the property restriction.
4. The intersection of two or more class descriptions, which creates a set of individuals based on an intersection. Intersection is formed by the AND operator, which is denoted by the symbol ∩. For example, an instance of SteelBridge is any instance of both Bridge and Steel classes shown in FIG. 19. This states that a steel bridge is both a bridge and made of steel.
5. The union of two or more class descriptions, which creates a set of individuals based on an intersection. Union is formed by the OR operator, which is denoted by the symbol ∪. For example, a Person might be equivalent to the union of Male OR Female classes (FIG. 20). FIG. 20 shows that a male is a person, and a female is a person.
6. The complement of a class describes a class for which the class excretion contains exactly the individuals that are complement to the class, i.e. do not belong to the class. The OWL 2 syntax is complementOf. For example, the class SteelBridge might have a compliment class called NonSteelBridge shown in model 3 below:

Model 3:

```
      <owl:Class>
<owl:complementOf>
    <owl:Class rdf:about=“#SteelBridge”/>
</owl:complementOf>
  </owl:Class>
```

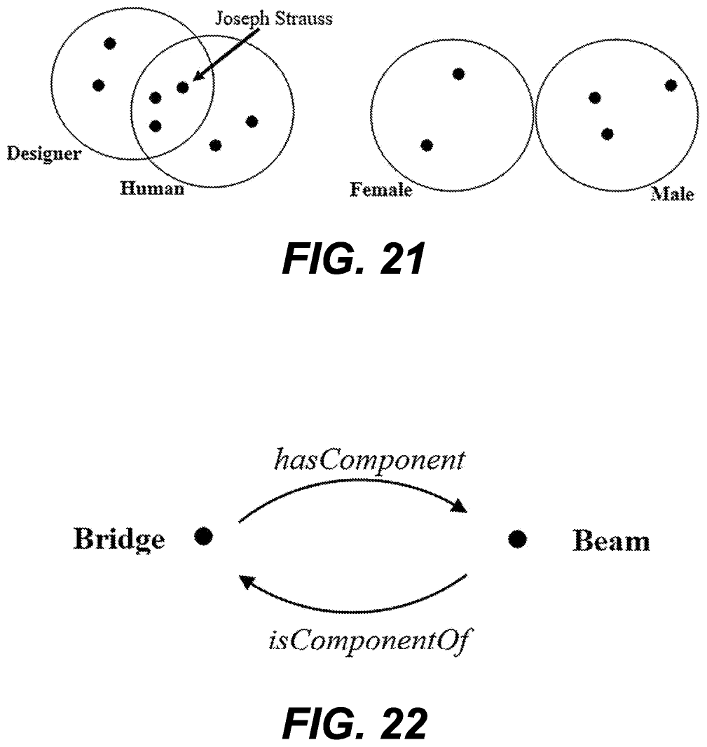

In OWL 2, all classes can be subclasses to the main class THING. A subclass is a smaller set with of a class with more distinct characteristics, and inversely a superclass is what a class belongs to. In the taxonomy, this can be referred to as the parent node and child node. A child node is a subclass of a parent node, and the parent node is the superclass of a child node.
Disjoint Classes: In OWL 2, classes are assumed to overlap and therefore are not disjoint by default. A class that is disjoint from another class cannot contain the same individual (i.e. an individual cannot belong to both classes that are disjoint). For example, “Joseph Strauss” is an individual of the class Designer. “Joseph Strauss” is also a human and a male, so he can be an individual of class Human and class Male, since these classes are not disjoint. In order to have disjoint classes, each class must be explicitly disjoint from another. Classes Male and Female need to be explicitly disjoint, so as an individual can either be a member of Male or Female (or neither). Therefore, since “Joseph Strauss” is an individual of class Male, he cannot be an individual of class Female. FIG. 21 displays representation of non disjoint classes (Designer and Human) and disjoint classes (Female and Male).

Properties: Properties are relations that link one individual to another. There are two main types of properties: Object and Datatype. There are other property characteristics that associate to these two main types, which include Inverse, Annotation, Functional, Transitive, and Symmetric. Naming conventions are trivial since the relation can be described by many different ways, but it is important to have them adequately described the relation. Also, object oriented programming conventions are also used, such as CamelCase.

Object Properties: An object property is a relationship between two individuals, in which property P relates individual A to individual B. For example, aggregation of parts would be considered object properties. Take for example hasPart. A bridge is composed of many parts, such as beams, columns, or walls. Since all these instances are objects, then they can be related to Bridge by hasPart. The syntax is owl: ObjectProperty.

Data Type Properties: DataType properties link instances to data values, in which property P relates individual A to value X. For example, hasCompressiveStrength or hasShearModulus are DataType properties associated with materials. The syntax is owl: DatatypeProperty.

Inverse Properties: Each defined relation has an inverse property. For example, if Bridge hasComponent Beam then the inverse would be Beam isComponentOf Bridge as shown in FIG. 22.

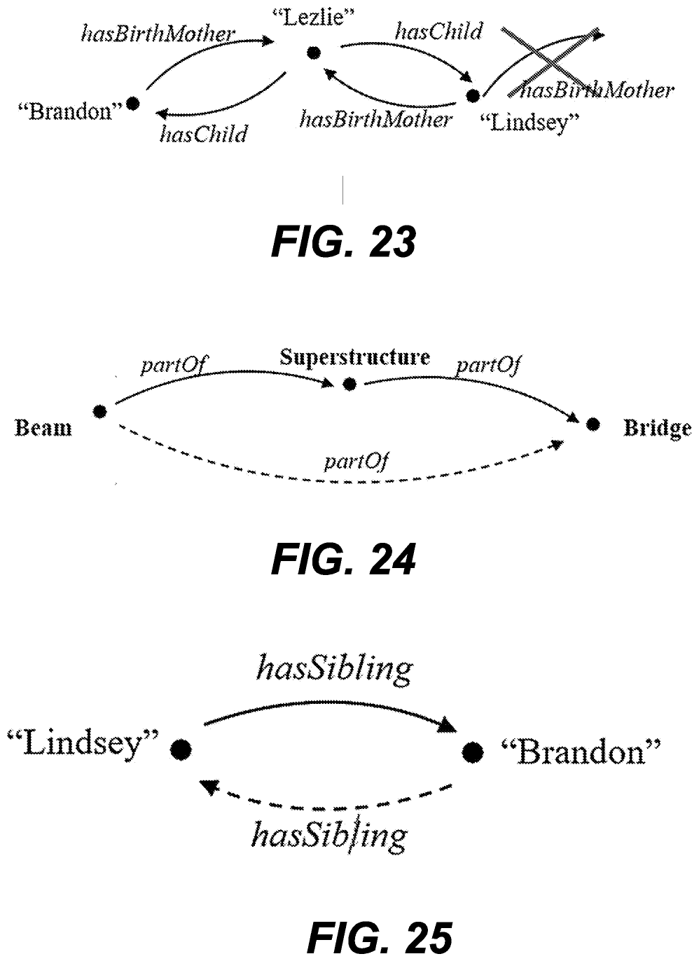

Functional Properties: A property is functional if, for any given individual, there can be at most one individual related. For example, a child (“Lindsey”) will only have one birth mother (“Lezlie”), and thus hasBirthMother is a functional property. However, a mother can have multiple children, thus hasChild is not functional (FIG. 23).

Transitive Properties: Transitive properties relate objects through another. For instance, a property, P, is transitive if it relates individual A to individual B, and also individual B to individual C, and thus can infer that individual A is related to individual C via property P. For example, if Beam is partOf Superstructure, and Superstructure is partOf Bridge, then Beam is also partOf Bridge (FIG. 24).

Symmetric Properties: Symmetric properties relate two objects by the same property. For instance, A is related to B by property P, and B is related to A by the same property P.A clear example is the sibling relationship: “Lindsey” hasSibling “Brandon”, and symmetrically “Brandon” hasSibling “Lindsey” (FIG. 25).

Annotation Properties: Annotated properties are used to add metadata to classes, individuals, and other properties. For example, name, definition, and other information are added to the object by the annotation property. OWL 2 has five main predefined annotations, which include:
1. owl: versionInfo—A string that defines the ontology version
2. rdfs:label—A string that adds names to elements
3. rdfs:seeAlso—A URI that can be used to link similar resources
4. rdfs:isDefinedBy—A URI that can be used to link to references
5. rdfs:comment—A string that adds more information to the elements

### Domain and Range

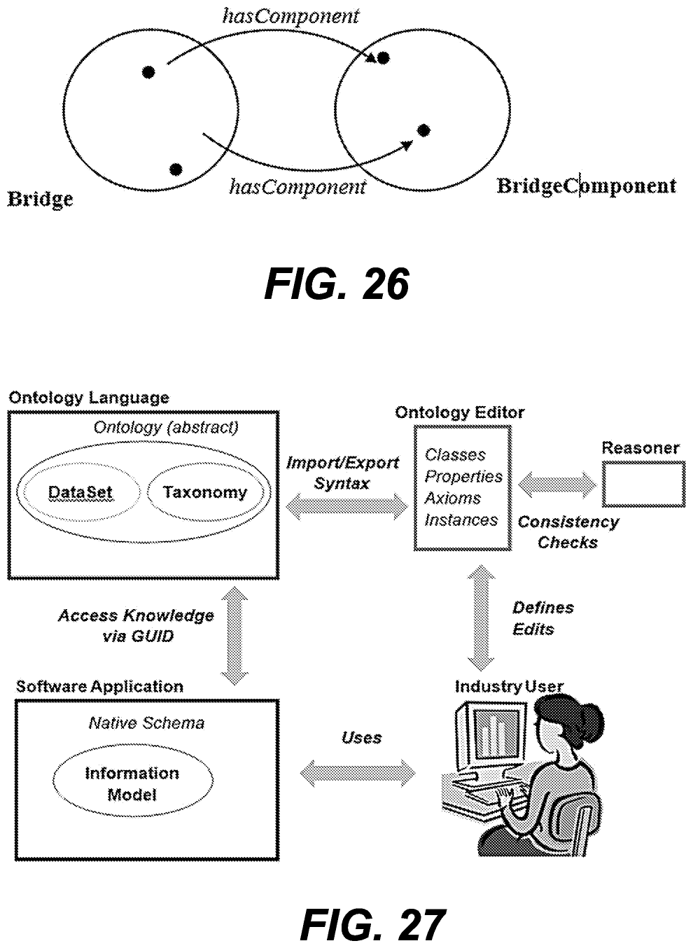

Properties can have domain and range axioms that can be used for additional constraints. A property links individuals from a domain to individuals from the range. For example, a bridge has various structural components, thus Bridge hasComponent BridgeComponent, thus the domain of hasComponent is Bridge and the range of hasComponent is BridgeComponent (FIG. 26). Additionally, the inverse property of hasComponent, isComponentOf, will have the inverse of domain and range.

### RDF Schema Constructs

OWL 2 uses the RDF (Resource Description Framework) schema to provide a data modeling vocabulary for RDF data in order to have a more expressive ontology language. The full guide for RFD implementation in OWL 2 can be found at (W3C, 2014). Tables 7-3 and 7-4 provide the summary of the RDF Schema Vocabulary.

TABLE 7-3
RDF Classes (W3C, 2014).

| Class | |
|---|---|
| name | Comment |
| rdfs:Resource | The class resource, everything. |
| rdfs:Literal | The class of literal values, e.g. textual strings and |
| | integers. |
| rdf:langString | The class of language-tagged string literal values. |
| rdf:HTML | The class of HTML literal values. |
| rdf:XMLLiteral | The class of XML literal values. |
| rdfs:Class | The class of classes. |
| rdf:Property | The class of RDF properties. |
| rdfs:Datatype | The class of RDF datatypes. |
| rdf:Statement | The class of RDF statements. |
| rdf:Bag | The class of unordered containers. |
| rdf:Seq | The class of ordered containers. |
| rdf:Alt | The class of containers of alternatives. |
| rdfs:Container | The class of RDF containers. |
| rdfs:ContainerMembershipProperty | The class of container membership properties, rdf:_ 1, |
| | rdf:_2, . . . , all of which are sub-properties of ′member′. |
| rdf:List | The class of RDF Lists. |

TABLE 7-4
RDF Properties (W3C, 2014).

| Property Name | Comment | Domain | Range |
|---|---|---|---|
| rdf:type | The subject is an instance of a class. | rdfs:Resource | rdfs:Class |
| rdfs:subClassOf | The subject is a subclass of a class. | rdfs:Class | rdfs:Class |
| rdfs:subProperty | The subject is a | rdf:Property | rdf:Property |
| Of | subproperty of a property. | | |
| rdfs:domain | A domain of the subject property. | rdf:Property | rdfs:Class |
| rdfs:range | A range of the subject property. | rdf:Property | rdfs:Class |
| rdfs:label | A human-readable name for the | rdfs:Resource | rdfs:Literal |
| | subject. | | |
| rdfs:comment | A description of the subject resource. | rdfs:Resource | rdfs:Literal |
| rdfs:member | A member of the subject resource. | rdfs:Resource | rdfs:Resource |
| rdf:first | The first item in the subject RDF list. | rdf: List | rdfs:Resource |
| rdf:rest | The rest of the subject RDF list | rdf:List | rdf:List |
| | after the first item. | | |
| rdfs:seeAlso | Further information about the | rdfs:Resource | rdfs:Resource |
| | subject resource. | | |
| rdfs:isDefinedBy | The definition of the subject | rdfs:Resource | rdfs:Resource |
| | resource. | | |
| rdf.value | Idiomatic property used for | rdfs:Resource | rdfs:Resource |
| | structured values. | | |
| rdf:subject | The subject of the subject | rdf:Statement | rdfs:Resource |
| | RDF statement. | | |
| rdf:predicate | The predicate of the subject | rdf:Statement | rdfs:Resource |
| | RDF statement. | | |
| rdf:object | The object of the subject RDF | rdf:Statement | rdfs:Resource |
| | statement. | | |

### Reasoner

It is beneficial to only constrain what is needed to accurately capture the meaning of domain knowledge. Over constraining the ontology may cause unexpected errors, so it is important to minimize constraining properties. Since OWL 2 is a declarative language, and not a programming language, tools called “reasoners” are used to infer the logic of the ontology. A reasoner performs consistency checks and tests the classification of instances. Therefore, if there are any errors in logic (e.g. over constraining) the reasoner will produce an error message for any inconsistencies. Additionally, using a reasoner on the classes in an ontology can compute the inferred ontology class hierarchy. There are various publicly available reasoners, many of which are free to use and may already be embedded in an ontology developer application.

### Criteria for Validation

Validation of the taxonomy is important for implementing into an ontology, and ontology validation is important for implementation into software applications. Chapter 6 highlighted industry validation (i.e. knowledge is validated), and it is imperative that the taxonomy and ontology also get validated with the domain experts to verify that each accurately represents the domain knowledge. The following describes the criteria needed to validate the taxonomy and ontology.
Sufficiency. The taxonomy and ontology needs to meet the needs of the domain requirements outlined in each Exchange Requirement (ER) documented in the Information Delivery Manual (IDM).
Clarity: The taxonomy and ontology should not contain any redundant or ambiguous terminology. Semantic clarity is important to be able to distinguish from similar terms and definitions.
Consistency: There should be no inconsistencies, duplications, or over constraints in the taxonomy and ontology. The use of reasoners or rule engines for consistency checking is recommended for the ontology, especially if property restrictions are used.
Reusability: The taxonomy and ontology need to be expanded and reused by other domains. The taxonomy and ontology also need to be accessible.
Expansibility. The taxonomy and ontology need to represent the fundamental knowledge needed to grow and expand.
Security: Once validated and approved, the taxonomy and ontology need to have safeguards in place to prevent unauthorized modifications. The taxonomy editor does allow for read-only protection once validated, but the final location needs to contain their own safeguards.
Implementable: The taxonomy needs to have sufficient attributes and axioms needed to be implemented into an ontology. Although a taxonomy may be limited by the amount of axioms in place, the supporting documentation (i.e. IDM) should explain the taxonomy used in full detail. Any discrepancies need to be address by the industry domain group and added to the documentation to support full ontology implementation. When fully implemented into an ontology with case examples fully vetted by industry users can a taxonomy be validated.

The ontology needs to have sufficient attributes and axioms needed to be implemented into a software application. Any discrepancies need to be address by both the industry domain group and software implementers, and added to the documentation to support full ontology implementation. When fully implemented in software case examples fully vetted by industry users, can an ontology be validated.

### Change Management

The current output for the processes (e.g. the IDM, taxonomy, and ontology) have been set up to be locked once approved and validated by the industry domain in order to prevent unauthorized modification. The ability to lock the output prevents mistakes, errors, or issues that may arise if any of the information has been changed or altered.

However, as technologies progress and new ideas or methods are created with the change in time, it is expected that the locked information will need to be modified accordingly. Therefore, it is imperative that a mechanism to allow for such changes be in place. Typically, the same process that the taxonomy and ontology went through initially to get validated and approved is the same process to validate and approve changes or additions. For example, if changes are needed for the steel erection IDM, those changes need to follow the same process outlined previously. Such mechanisms already exist in practice, and are outlined below.

Documents: Any published documents, such as an IDM or standards, can either have addendums attached, new editions, or new volumes. Modifications need to be submitted to the organizing body in charge of maintaining and approving specifications. Any changes to the documents need to be reflected in the associated taxonomy and ontology.

Taxonomy: An approved taxonomy will have safeguards in place to prevent unauthorized modifications. Any new terms added, or changes to locked terms need to be submitted to the organizing body in charge of maintaining and overseeing the taxonomy. The approval process that is established by the organizing body needs to be adhered to, as well as making the appropriate changes to the associated documents and ontology. The criteria for validation of the modified taxonomy need to be followed.

Ontology: An approved ontology will have safeguards in place to prevent unauthorized modifications. Any new terms added, or changes to the locked ontology need to be submitted to the organizing body in charge of maintaining and overseeing the ontology. The approval process that is established by the organizing body needs to be adhered to, as well as making the appropriate changes to the associated documents and taxonomy. In addition to following the criteria for validation of the modified ontology, a reasoner should be used for consistency checking.

### Software Implementation

The ontology provides the description logic needed for software. However, ontology languages, such as OWL, are not executable languages needed to program software applications. In other words, an ontology language alone cannot be used to develop software applications, but needs executable computer languages (e.g., EXPRESS, java, c#, JSON) to develop the software applications. In such, the ontology language is used in conjunction with the native schema of the software application.

FIG. 27 displays the high level of framework of an ontology being implemented into a software application. The industry user defines and edits the ontology by the use of an ontology editor, which performs consistency checks via a reasoner (either a separate or embedded in the editor). The ontology is exported to an appropriate syntax that can be used by software applications to access the knowledge via a GUID. The software application uses a native schema for a specific computer language to represent the information model. Finally, the domain user can use the software application, and make any changes to the ontology via the editor. Note that FIG. 27 is only a representation of how the domain user, ontology, and software application interact, and thus, reality may not be as simple as depicted. For example, the domain experts that define and edit the ontology may not be the same as the users. The process to validate and approve the modified ontology is also not depicted.

Case Study: Ontology and Software Implementation Prototype: The BrIM ontology was created based of the information provided by the BrIM taxonomy. The BrIM ontology was created with Protége developed by Stanford Center for Biomedical Informatics Research (2015). A simple case study example is detailed below, but full specifications of using the Protégé editor can be found at the Protégé wiki page (Protégé, 2016).

In order to create the ontology, additional axioms are needed to provide more assertions to what has been defined in the taxonomy. OWL 2 is composed of classes, and so each term of the BrIM taxonomy needed to be either classified as an object class, object property, data property, or value associated to a property. For example, physical components (e.g. beam, column, girder) are defined as classes, the relationships between objects (e.g. bridge structure contains beams) are defined as object properties, the relationships between objects (the Bride Identification Number (BIN) is 75132542) and values are defined as data properties, and the values (number, weight, length) are defined as values.

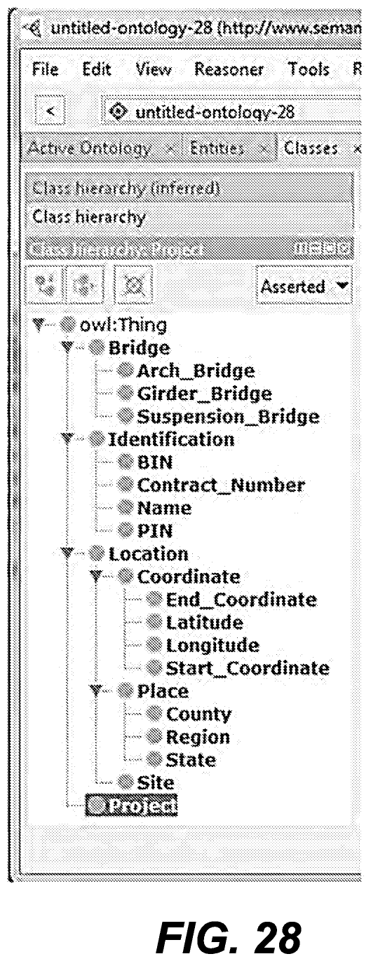

The example comprises a simple bridge project at a specific location. The main classes defined in OWL for this example include “Bridge”, “Identification,” “Location,” and “Project” (FIG. 28). Each class has respective subclasses.

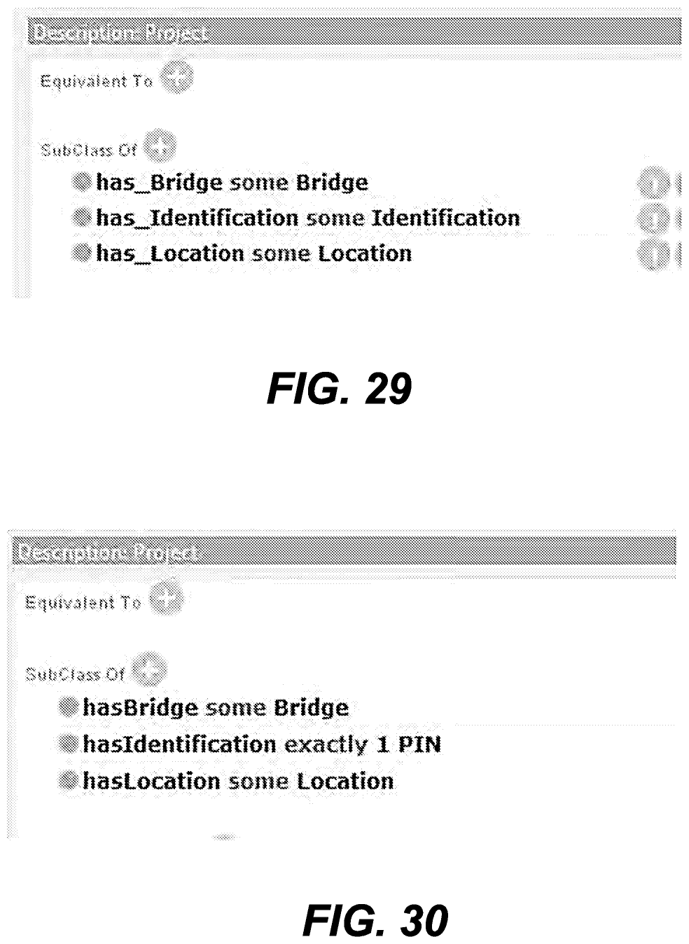

Next, axioms were defined by the way of object properties to set relationships between the object. According to the BrIM taxonomy, a project is defined by having a bridge, identification, and location. Therefore, the following object properties were defined: has_Bridge, has_Identification, and has_Location. Using OWL 2 property restrictions, the following subclasses were defined (FIG. 29). The property restrictions state that a project needs a bridge, identification, and location associated with it.

Data properties were defined to assign data values to object classes. For example, hasNumber can associate any object to any numbers. This is the case for the project identification number (PIN). Any property restriction can have cardinality, including less than, more than, or exactly. Since a project has only one PIN associate, the cardinality of has_Identification was changed to exactly one pin (FIG. 30).

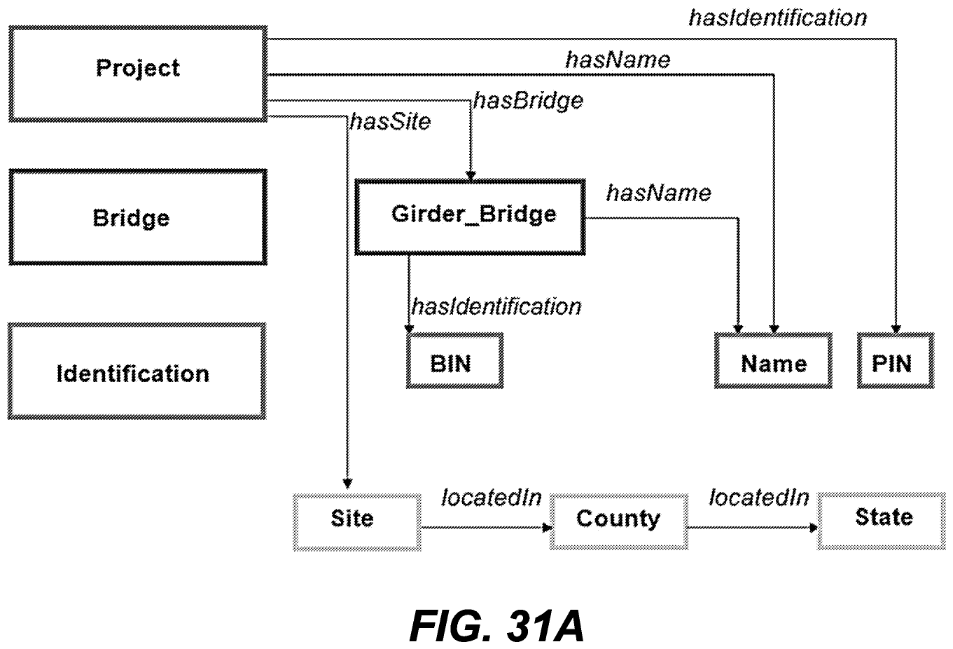

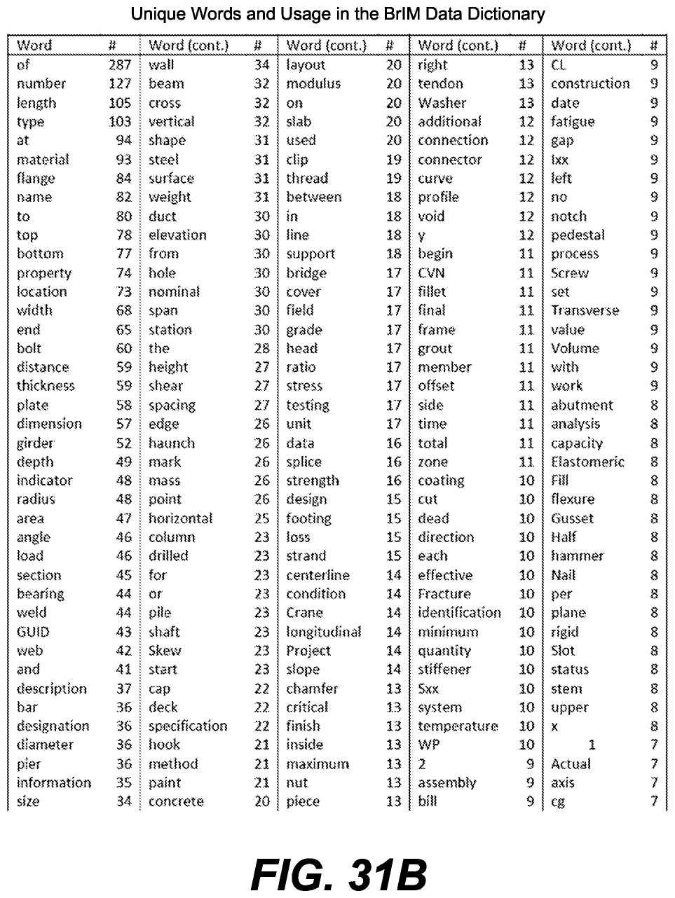

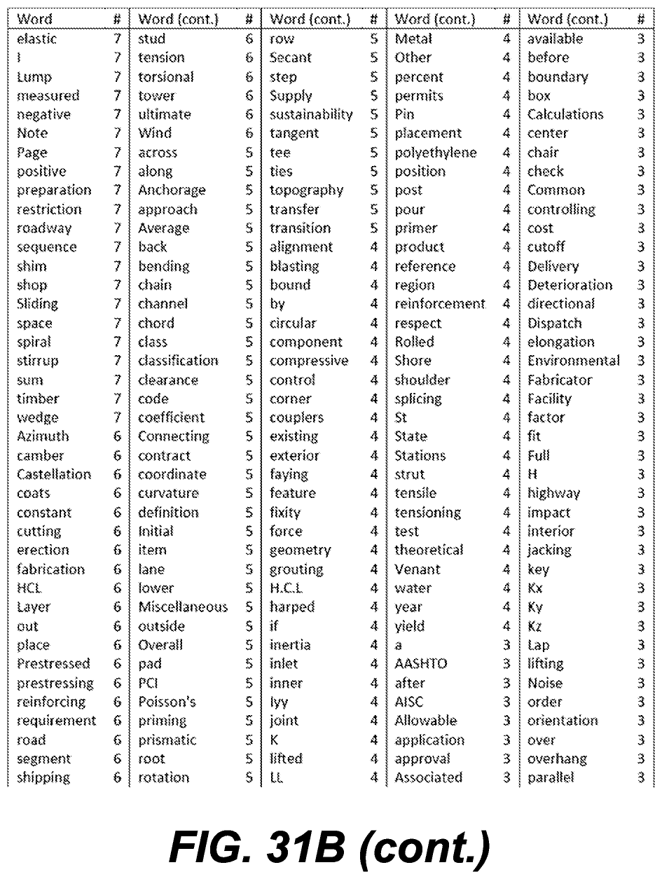

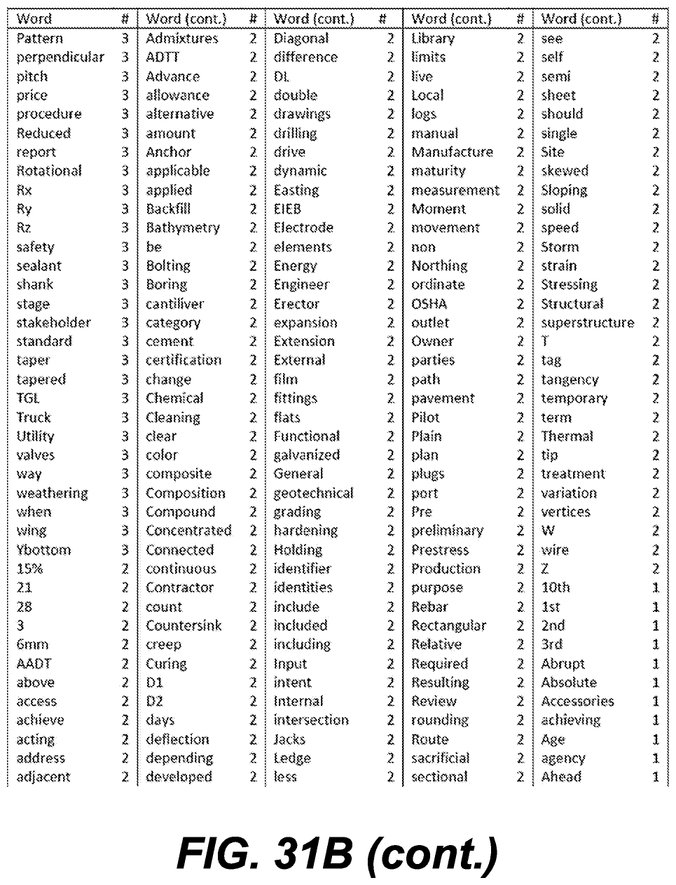

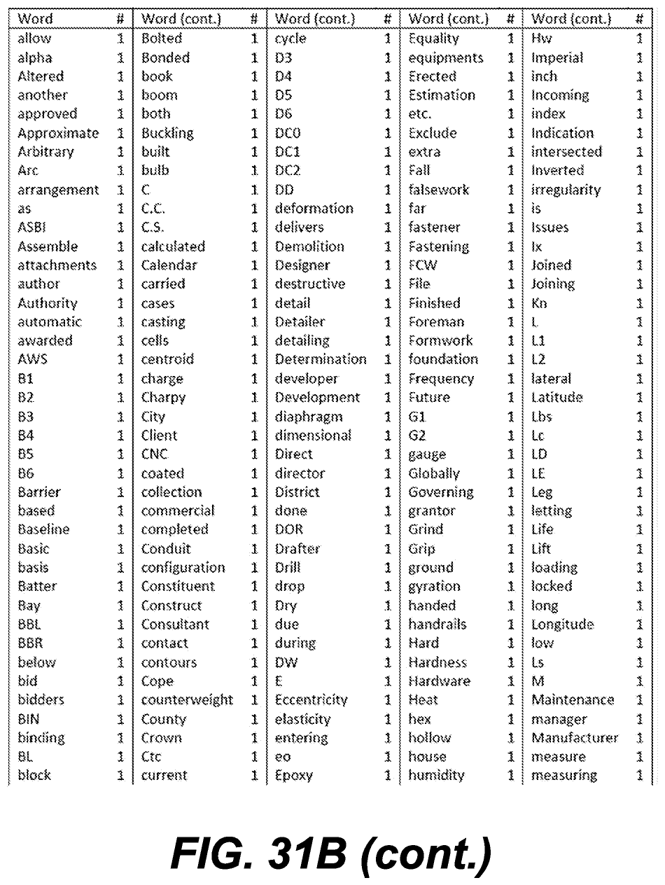

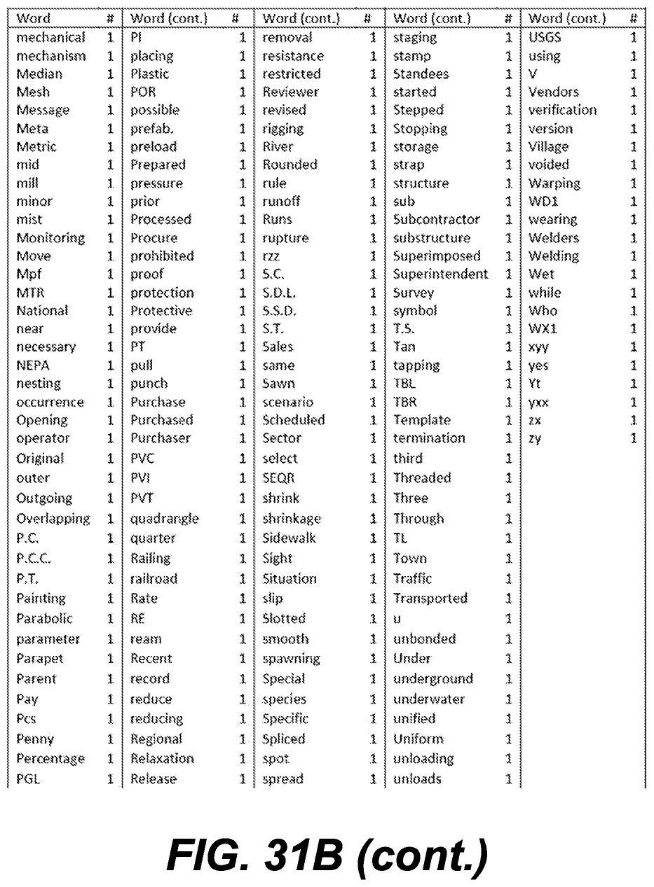

Additional axioms were defined to complete the ontology. Finally, a prototype software application program was developed in c# to test the framework in FIG. 31A. The purpose of the application is to validate the framework and to demonstrate the feasibility that an ontology language (e.g., OWL) can provide the logic that can be used with an executable program language (e.g., c#). A portion of the BrIM taxonomy was implemented into an ontology using the Protégé ontology editor. FIG. 31A displays the relationships used in the application to create a bridge project.

Note the reuse of properties, such as hasName, hasIdentification, and locatedIn. This is an example of how the ontology can be developed to promote reuse, while being semantically consistent. The hasIdentification could have been defined as hasPIN and hasBIN, but since both PIN and BIN are both subclasses of Identification, then the most general class, Identification, was used to define the property.

The discussed prototype application showed the feasibility of using an ontology language to provide the structure to transfer domain knowledge. Each software application is capable of accessing the ontology by integrating the proper syntax, such as RDF/XML, and can produce more elaborate functionalities.

### Taxonomy Editor Data Analytics

Manually entering terms can cause errors that may reflect in the final taxonomy. Manual entries that cause errors include misspellings, having plural form of a word (i.e. number agreement), different letter case (e.g. upper and lower case), and abbreviations. Additionally, having duplicate forms of a word to mean the same thing (e.g. plural, abbreviations, and symbols) can cause redundancies. Having one defined term (designated by a GUID) and using automation to assign the term will drastically reduce these errors and redundancies. Additionally, changes to the original term will automatically change all the instances.

Data analytics were performed on the BrIM Data Dictionary produced by (Hu, 2014) that was used in TG-10/TG-15. Scripts were written in C# to parse through the file to analyze the data diction in various ways. The purpose of the data analytics was the show the errors of manually typing in terms to a taxonomy.

The English language is very complex with all the rules and forms of a word. It may sound weird to the ear in spoken English when the singular form of the word is paired with multiple objects, e.g. “one people”, “one bridge,” or vice versa “five person,” “five bridge.” However, the computer doesn't care about how it sounds, and programming plural forms can cause semantic issues, since computers view “people” and “person” as different objects. For example, string compare of the two words will result in false, meaning that the two words are not the same. The only way around these issues is to include sophisticated rule sets or conditionals. Therefore, to reduce the programming complexity while maintaining integrity of semantics, it is important to keep to the “object” and “quantity” format, such as “person” “5.” Although there are cases where the plural form of the word signifies a totally different meaning (e.g. “shear” meaning to cut, and “shears” meaning scissors), these cases are solved by having the two separate words as independent entries in the taxonomy, where each gets its own GUID. This also includes the same spelling of a word with different meaning. The GUID indicates the definition that is meant with the word.

The BrIM DD has 2048 individual entities, which is designated by a single cell per entity. However, some of the entities had multiple words associated. For humans, this is easily readable, but for a machine it inhibits readability. This is one of the reasons why it is important to populate a taxonomy, so each entity will have one term (or grouping if it is an axiom). Therefore, each word was extracted from the cells. The total amount of words in the BrIM DD is 6811. However, as mentioned before, the manual data entry inherently allows for errors and redundant data, and so the distinct words were extracted.

The first extraction took out all of the distinct words, but did not discern about any of the errors. For instance the following are distinct words: “beam,” “beams,” “Beams” and “baem.” Although they are all variation of the word “beam”, they each count as a distinct word. The total number of distinct words was 1394. Next, the script did not account for case sensitive words, and the results reduced to 1101 words. Finally, all errors and plural forms were removed, leaving only the unique word. The final word count was 983. This means of the 6811 words in the BrIM DD, only 983 (14.4%) unique words were used. Further analysis showed that there were 411 errors, which would result in further semantic issues and interoperability issues. This means that 30% of the distinct words were in fact erroneous. Tables 7-5 and 7-6 show additional break down of the data analytics. It is important to note only the abbreviations that mean the same as the non-abbreviated word were taken out and not acronyms. For instance, “min.” for “minimum” was taken out, but “AASHTO” was not. Moreover, some common abbreviations used in industry were left in as well (e.g. CL for center line), so technically the unique word count and error count may fluctuate plus or minus a few.

TABLE 7-5
Data Analytics of Data Entries of the BrIM Data Dictionary

| | |
|---|---|
| Total Entries | 2048 |
| Total Words | 6811 |
| Distinct Words | 1394 |
| Unique Words | 983 |
| Percentage Unique | 14.4% |

TABLE 7-6
Errors Found in the Distinct Words

| | | |
|---|---|---|
| Case errors | 293 | 71.3% |
| Plural | 98 | 23.8% |
| Abbreviation | 15 | 3.6% |
| misspellings | 5 | 1.2% |
| Total Error | 411 | |

After the errors were fixed, the instances of the unique words were counted. The top 20 words used are listed in Table 7-7. The rest of the words can be found in FIG. 31B.

TABLE 7-7
Top 20 Used Words in the BrIM Data Dictionary

| Word | Instances |
|---|---|
| of | 287 |
| number | 127 |
| length | 105 |
| type | 103 |
| at | 94 |
| material | 93 |
| flange | 84 |
| name | 82 |
| to | 80 |
| top | 78 |
| bottom | 77 |
| property | 74 |
| location | 73 |
| width | 68 |
| end | 65 |
| bolt | 60 |
| distance | 59 |
| thickness | 59 |
| plate | 58 |
| dimension | 57 |

Based on the results, the most word used is “of” at 287 instances. This is significant because it is not an actual term, but rather a description of a term. The word “of” expresses the part-whole relationship, which is one of the most used axioms.

Moreover, the majority of instances are in fact not terms, but attributes or descriptions used in defining properties or terms. This is important because the human language uses attributes to describe terms, and thus displays the semantic issues that a machine might experience. Therefore, it is imperative to reduce these semantics by the use of a taxonomy and ontology.

Dealing with the root word of terms with different tenses is out of this current scope, since it requires more significant analysis to determine the meaning of each case. For example, “developer,” “developed,” “development,” and “developing” all have the root word “develop.” but since they may have slightly different meaning or uses, they were left as is. However, taking consideration of the root and its variations is important to consider in future research.

After the Data Dictionary was reduced to the unique words, the next step was to transform those unique words into the DataSet format. This format has the following fields (in order): “GUID,” “Abbreviation,” “Term,” “Definition,” “Notes,” “Related,” “Validate,” “Reference Code,” “Source,” and “Date.” The Taxonomy Editor does have a template that a user can download. It is important that the template is used before it is imported into the editor, as it can produce errors. Chapter 6 explained each field in more detail. One significant advantage is that the user can also define and upload their own templates using either Excel or XML.

Since not all of the 983 unique words in the BrIM Data Diction are terms, not all need to be incorporated into the DataSet. However, these non-terms are important because they provide details about the term and will be used in the formation of attributes and axioms. One major word is “of,” since it, by definition, expresses the part-whole relationship and will be used in axioms such as “composed of,” “subset of,” and “direction of.”

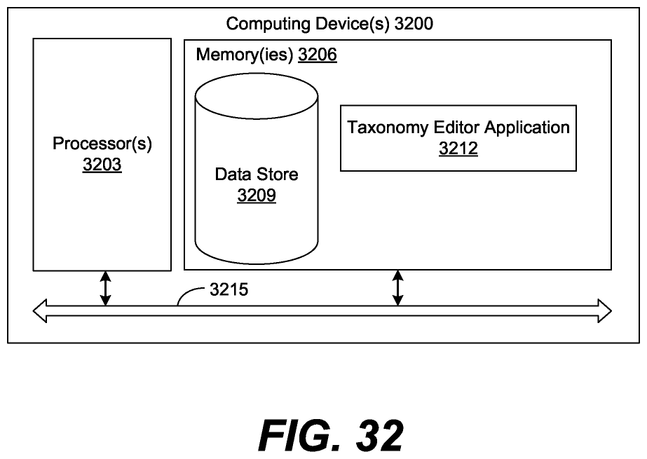

With reference to FIG. 32, shown is a schematic block diagram of a computing device 3200 that can be utilized to execute a taxonomy editor application 3212 for automating the construction and organization of a taxonomy. In some embodiments, among others, the computing device 3200 may represent a mobile device (e.g. a smartphone, tablet, computer, etc.). Each computing device 3200 includes at least one processor circuit, for example, having a processor 3203 and a memory 3206, both of which are coupled to a local interface 3215. To this end, each computing device 3200 may comprise, for example, at least one server computer or like device. The local interface 3215 may comprise, for example, a data bus with an accompanying address/control bus or other bus structure as can be appreciated.

Stored in the memory 3206 are both data and several components that are executable by the processor 3203. In particular, stored in the memory 3206 and executable by the processor 3203 are a taxonomy editor application 3212 and potentially other applications. Also stored in the memory 3206 may be a data store 3209 and other data. In addition, an operating system may be stored in the memory 3206 and executable by the processor 3203.

It is understood that there may be other applications that are stored in the memory 3206 and are executable by the processor 3203 as can be appreciated. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Flash®, or other programming languages.

A number of software components are stored in the memory 3206 and are executable by the processor 3203. In this respect, the term “executable” means a program file that is in a form that can ultimately be run by the processor 3203. Examples of executable programs may be, for example, a compiled program that can be translated into machine code in a format that can be loaded into a random access portion of the memory 3206 and run by the processor 3203, source code that may be expressed in proper format such as object code that is capable of being loaded into a random access portion of the memory 3206 and executed by the processor 3203, or source code that may be interpreted by another executable program to generate instructions in a random access portion of the memory 3206 to be executed by the processor 3203, etc. An executable program may be stored in any portion or component of the memory 3206 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 3206 is defined herein as including both volatile and nonvolatile memory and data storage components. Volatile components are those that do not retain data values upon loss of power. Nonvolatile components are those that retain data upon a loss of power. Thus, the memory 1306 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 3203 may represent multiple processors 3203 and/or multiple processor cores and the memory 3206 may represent multiple memories 3206 that operate in parallel processing circuits, respectively. In such a case, the local interface 3215 may be an appropriate network that facilitates communication between any two of the multiple processors 3203, between any processor 3203 and any of the memories 3206, or between any two of the memories 3206, etc. The local interface 3215 may comprise additional systems designed to coordinate this communication, including, for example, performing load balancing. The processor 3203 may be of electrical or of some other available construction.

Although the taxonomy editor application 3212 and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

Also, any logic or application described herein, including the taxonomy editor application 3212, that comprises software or code can be embodied in any non-transitory computer-readable medium for use by or in connection with an instruction execution system such as, for example, a processor 3203 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including the taxonomy editor application 3212, may be implemented and structured in a variety of ways. For example, one or more applications described may be implemented as modules or components of a single application. Further, one or more applications described herein may be executed in shared or separate computing devices or a combination thereof. For example, a plurality of the applications described herein may execute in the same computing device 3200, or in multiple computing devices in the same computing environment. Additionally, it is understood that terms such as “application,” “service,” “system,” “engine,” “module,” and so on may be interchangeable and are not intended to be limiting.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

The term “substantially” is meant to permit deviations from the descriptive term that don't negatively impact the intended purpose. Descriptive terms are implicitly understood to be modified by the word substantially, even if the term is not explicitly modified by the word substantially.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

1. A system, comprising:
a computing device comprising a processor and a memory; and
machine readable instructions stored in the memory that, when executed by the processor, cause the computing device to at least:
receive an input that identifies a term and a definition of the term;
generate a globally unique identifier (GUID) that uniquely identifies the input;
store the input and the GUID in a data store; and
assign the input and the GUID to a taxonomy tree, wherein the input and the GUID are assigned to a node within a hierarchy of the taxonomy tree.

2. The system of claim 1, wherein the machine readable instructions that, when executed by the processor, further cause the computing device to export the taxonomy tree as an Excel or XML file.

3. The system of claim 2, wherein the machine readable instructions cause the computing device to store the taxonomy tree as an Excel or XML file and further cause the computing device to bi-directionally convert the taxonomy tree from the Excel to the XML file.

4. The system of claim 1, wherein the hierarchy comprises one or more sub-nodes, the one or more sub-nodes sharing one or more attributes with the node.

5. The system of claim 1, wherein the taxonomy tree is configured to be automatically mapped to an ontology.

6. The system of claim 5, wherein the ontology comprises a World Wide Web Consortium (W3C) format.

7. The system of claim 5, wherein the ontology comprises a Web Ontology Language (OWL).

8. The system of claim 1, wherein the input further identifies at least one of a source of the term, a date of when the definition was created, an abbreviation of the term, one or more related terms, a validation indicator, or a reference code.

9. The system of claim 1, wherein the input is imported and exported, either in an XML format or an Excel format.

10. The system of claim 1, wherein the input is configured to be locked from editing once stored in the data store.

11. A method, comprising:
receiving, by a computing device, an input identifying a term and a definition of the term;
generating, by the computing device, a globally unique identifier (GUID) that uniquely identifies the input; and
assigning, by the computing device, the input and the GUID to a taxonomy tree, wherein the input and the GUID are assigned to a node within a hierarchy of the taxonomy tree.

12. The method of claim 11, comprising mapping the taxonomy tree to an ontology.

13. The method of claim 12, wherein the ontology comprises a World Wide Web Consortium (W3C) format.

14. The method of claim 13, wherein the W3C format comprises a Web Ontology Language (OWL) or Resource Description Framework.

15. The method of claim 12, comprising storing the input in a data dictionary, wherein the stored input is identifiable by the corresponding GUID.

16. The method of claim 15, wherein the stored data, taxonomy and ontology are locked after validation.

17. The method of claim 12, wherein the taxonomy tree is stored in a data store in Excel or XML format, wherein the stored taxonomy tree is configured for bi-directionally conversion between Excel and XML formats.

18. The method of claim 11, wherein the input can be imported or exported in either in XML or Excel format.

19. The method of claim 11, wherein the input further identifies at least one of a source of the term, a date of when the definition was created, an abbreviation of the term, one or more related terms, a validation indicator, or a reference code.

20. The method of claim 11, wherein the hierarchy comprises one or more sub-nodes, the one or more sub-nodes sharing one or more attributes with the node.
